(19) United States
(12) Patent Application Publication
(10) Pub. No.: US 2025/0175824 A1
(43) Pub. Date: May 29, 2025

(54) DATA COLLECTION PROCEDURE AND MODEL TRAINING

(71) Applicant: QUALCOMM Incorporated, San Diego, CA (US)

(72) Inventors: Chenxi HAO, Beijing (CN); Xipeng ZHU, San Diego, CA (US); Runxin WANG, San Diego, CA (US); Taesang YOO, San Diego, CA (US); June NAMGOONG, San Diego, CA (US); Jay Kumar SUNDARARAJAN, San Diego, CA (US); Yu ZHANG, San Diego, CA (US); Pavan Kumar VITTHALADEVUNI, San Diego, CA (US); Juan ZHANG, Beijing (CN); Krishna Kiran MUKKAVILLI, San Diego, CA (US); Tingfang JI, San Diego, CA (US); Naga BHUSHAN, San Diego, CA (US)

(21) Appl. No.: 18/841,919

(22) PCT Filed: Apr. 29, 2022
(86) PCT No.: PCT/CN2022/090624

§ 371 Date: Aug. 27, 2024

(51) Int. Cl. H04W 24/08; H04L 41/16; H04W 8/24

(52) U.S. Cl. CPC H04W 24/08; H04L 41/16; H04W 8/24

(57) ABSTRACT

In a wireless communication system, a user equipment (UE) vendor and a network entity vendor may configure one or more UEs and network entities to perform data collection, and to train for channel status information (CSI) feedback (CSF) models.

### CROSS-REFERENCE TO RELATED APPLICATIONS

This application is a 35 U.S.C. § 371 National Phase Application of PCT Application Serial No. PCT/CN2022/090624, entitled “DATA COLLECTION PROCEDURE AND MODEL TRAINING” and filed Apr. 29, 2022, the disclosure of which is expressly incorporated by reference herein in the entirety.

### BACKGROUND

### Technical Field

The present disclosure relates generally to communication systems, and more particularly, to training encoders and decoders associated with user equipments (UEs) and network entities, respectively.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a non-transitory computer-readable medium, and an apparatus for a user equipment (UE) vendor are provided. The method includes training one or more encoder-decoder pairs based on a raw dataset of the UE vendor; generating one or more training sets based on outputs of one or more encoders running the raw dataset of the UE vendor; and communicating the one or more training sets to a network entity vendor.

The present disclosure also provides an apparatus (e.g., a UE vendor/server) including a memory storing computer-executable instructions and at least one processor configured to execute the computer-executable instructions to perform the above method, an apparatus including means for performing the above method, and a non-transitory computer-readable medium storing computer-executable instructions for performing the above method.

In another aspect, the disclosure provides a method, a non-transitory computer-readable medium, and an apparatus for a UE vendor. The method includes training one or more encoder-decoder pairs based on a raw dataset of the UE vendor; generating two training sets for each of the one or more encoder-decoder pairs based on outputs of one or more encoders running the raw dataset of the UE vendor; and communicating the two training sets to a network entity vendor.

The present disclosure also provides an apparatus (e.g., a UE vendor/server) including a memory storing computer-executable instructions and at least one processor configured to execute the computer-executable instructions to perform the above method, an apparatus including means for performing the above method, and a non-transitory computer-readable medium storing computer-executable instructions for performing the above method.

In another aspect, the disclosure provides a method, a non-transitory computer-readable medium, and an apparatus for a network entity vendor. The method includes receiving one or more training sets from a UE vendor, the one or more training sets corresponding to one or more encoder-decoder pairs; and training one or more decoders associated with the one or more training sets.

The present disclosure also provides an apparatus (e.g., a network entity vendor/server) including a memory storing computer-executable instructions and at least one processor configured to execute the computer-executable instructions to perform the above method, an apparatus including means for performing the above method, and a non-transitory computer-readable medium storing computer-executable instructions for performing the above method.

In another aspect, the disclosure provides a method, a non-transitory computer-readable medium, and an apparatus for a network entity vendor. The method includes receiving two training sets from a UE vendor, the two training sets corresponding to one or more encoder-decoder pairs; and training one or more decoders associated with the two training sets.

The present disclosure also provides an apparatus (e.g., a network entity vendor/server) including a memory storing computer-executable instructions and at least one processor configured to execute the computer-executable instructions to perform the above method, an apparatus including means for performing the above method, and a non-transitory computer-readable medium storing computer-executable instructions for performing the above method.

In another aspect, the disclosure provides a method, a non-transitory computer-readable medium, and an apparatus for a UE. The method includes receiving a training data request from a UE vendor; transmitting the training data request to a network entity; receiving a data collection configuration message from the network entity in response to transmitting the training data request; transmitting a data collection configuration acknowledgement (ACK) to the network entity in response to receiving the data collection configuration message; performing a data collection procedure based on the data collection configuration message; and uploading one or more data to the UE vendor based on performing the data collection procedure.

The present disclosure also provides an apparatus (e.g., a UE) including a memory storing computer-executable instructions and at least one processor configured to execute the computer-executable instructions to perform the above method, an apparatus including means for performing the above method, and a non-transitory computer-readable medium storing computer-executable instructions for performing the above method.

In another aspect, the disclosure provides a method, a non-transitory computer-readable medium, and an apparatus for a network entity. The method includes receiving a training data request from a UE; transmitting a data collection configuration message to the UE in response to receiving the training data request; receiving a data collection configuration ACK from the UE in response to transmitting the data collection configuration message; and performing a data collection procedure based on the data collection configuration message.

The present disclosure also provides an apparatus (e.g., a network entity) including a memory storing computer-executable instructions and at least one processor configured to execute the computer-executable instructions to perform the above method, an apparatus including means for performing the above method, and a non-transitory computer-readable medium storing computer-executable instructions for performing the above method.

In another aspect, the disclosure provides a method, a non-transitory computer-readable medium, and an apparatus for a UE. The method includes receiving a data collection configuration message from a network entity based on a training data request; transmitting a data collection configuration ACK to the network entity in response to receiving the data collection configuration message; performing a data collection procedure based on the data collection configuration message; and reporting training data between the network entity, a UE vendor, and a network entity vendor based on performing the data collection procedure.

The present disclosure also provides an apparatus (e.g., a UE) including a memory storing computer-executable instructions and at least one processor configured to execute the computer-executable instructions to perform the above method, an apparatus including means for performing the above method, and a non-transitory computer-readable medium storing computer-executable instructions for performing the above method.

In another aspect, the disclosure provides a method, a non-transitory computer-readable medium, and an apparatus for a network entity. The method includes receiving a training data request from a network entity vendor; transmitting a data collection configuration message to a UE in response to receiving the training data request; receiving a data collection configuration ACK from the UE in response to transmitting the data collection configuration message; performing a data collection procedure based on the data collection configuration message; and reporting training data between the UE, a UE vendor, and a network entity vendor based on performing the data collection procedure.

The present disclosure also provides an apparatus (e.g., a network entity) including a memory storing computer-executable instructions and at least one processor configured to execute the computer-executable instructions to perform the above method, an apparatus including means for performing the above method, and a non-transitory computer-readable medium storing computer-executable instructions for performing the above method.

In another aspect, the disclosure provides a method, a non-transitory computer-readable medium, and an apparatus for a UE vendor. The method includes communicating a training data request to initiate a model training for the UE vendor and a network entity vendor; receiving a training data report in response to communicating the training data request; performing the model training for channel status information (CSI) feedback (CSF) models; and communicating a model training report to the network entity vendor.

The present disclosure also provides an apparatus (e.g., a UE vendor.server) including a memory storing computer-executable instructions and at least one processor configured to execute the computer-executable instructions to perform the above method, an apparatus including means for performing the above method, and a non-transitory computer-readable medium storing computer-executable instructions for performing the above method.

In another aspect, the disclosure provides a method, a non-transitory computer-readable medium, and an apparatus for a network entity vendor. The method includes communicating a training data request to initiate a model training for a UE vendor and the network entity vendor; receiving a training data report in response to communicating the training data request; performing the model training for CSF models; and communicating a model training report to the UE vendor.

The present disclosure also provides an apparatus (e.g., a network entity vendor/server) including a memory storing computer-executable instructions and at least one processor configured to execute the computer-executable instructions to perform the above method, an apparatus including means for performing the above method, and a non-transitory computer-readable medium storing computer-executable instructions for performing the above method.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system including an access network, in accordance with certain aspects of the present description.

FIG. 2A is a diagram illustrating an example of a first frame, in accordance with certain aspects of the present description.

FIG. 2B is a diagram illustrating an example of downlink (DL) channels within a subframe, in accordance with certain aspects of the present description.

FIG. 2C is a diagram illustrating an example of a second frame, in accordance with certain aspects of the present description.

FIG. 2D is a diagram illustrating an example of uplink (UL) channels within a subframe, in accordance with certain aspects of the present description.

FIG. 3 is a diagram illustrating an example of a base station and user equipment (UE) in an access network, in accordance with certain aspects of the present description.

FIG. 4 shows a diagram illustrating an example disaggregated base station architecture.

FIG. 5 is a diagram illustrating an example of an communication system including a UE vendor and a gNB vendor.

FIG. 6 is a diagram illustrates a conceptual diagram of channel status information (CSI) feedback (CSF) compression between a UE and a network entity in a wireless communication system.

FIG. 7 illustrates a conceptual diagram of an inner-loop in the UE vendor training for one encoder-decoder pair.

FIG. 8 is a message diagram illustrating example messages for a data collection procedure for CSF compression.

FIG. 9 is a conceptual diagram illustrating an example frame structure for uploading data.

FIG. 10 is a message diagram illustrating example messages for a data collection procedure for CSF compression.

FIG. 11 is a message diagram illustrating example messages for step reporting training data during a data collection procedure for CSF compression.

FIG. 12 is a message diagram illustrating example messages for a data collection procedure for CSF compression.

FIG. 13 illustrates an example messages for requesting existing data upload to a repository.

FIG. 14 illustrates another example messages for requesting existing data upload to a repository.

FIG. 15 illustrates another example messages for requesting existing data upload to a repository.

FIG. 16 is a message diagram illustrating example messages for a data collection procedure and offline model training for CSF compression using area based training at a UE.

FIG. 17 is a message diagram illustrating example messages for a data collection procedure and offline model training for CSF compression using UE based configuration at a UE.

FIG. 18 is a conceptual diagram illustrating an example frame structure for uploading data.

FIG. 19 is a message diagram illustrating example messages for a data collection procedure and offline model training for CSF compression using area based training at a UE.

FIG. 20 is a message diagram illustrating example messages for a data collection procedure and offline model training for CSF compression using UE based training at a UE.

FIG. 21 is a message diagram 2100 illustrating example messages for step reporting training data during a data collection procedure for CSF compression.

FIG. 22 is a conceptual data flow diagram illustrating the data flow between different means/components in an example base station.

FIG. 23 is a conceptual data flow diagram illustrating the data flow between different means/components in an example UE.

FIG. 24 is a flowchart of an example method for a UE vendor for cross-node machine learning training.

FIG. 25 a flowchart of an example method for a UE vendor for cross-node machine learning training.

FIG. 26 is a flowchart of an example method for a network entity vendor for cross-node machine learning training.

FIG. 27 is a flowchart of an example method for a network entity vendor for cross-node machine learning training.

FIG. 28 is a flowchart of an example method for a UE to perform a CSF data collection procedure.

FIG. 29 is a flowchart of an example method for a network entity to perform a CSF data collection procedure.

FIG. 30 is a flowchart of an example method for a UE to perform a CSF data collection procedure.

FIG. 31 is a flowchart of an example method for a network entity to perform a CSF data collection procedure.

FIG. 32 is a flowchart of an example method for a UE vendor to perform data collection and offline model training for CSF compression.

FIG. 33 is a flowchart of an example method for a network entity vendor to perform data collection and offline model training for CSF compression.

An Appendix is included that is part of the present application and provide additional details related to the various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Although the following description may be focused on 5G NR, the concepts described herein may be applicable to other similar areas, such as LTE, LTE-A, CDMA, GSM, and other wireless technologies.

In an aspect, the present disclosure provides techniques for training encoders and decoders associated with user equipments (UEs) and network entities, respectively.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

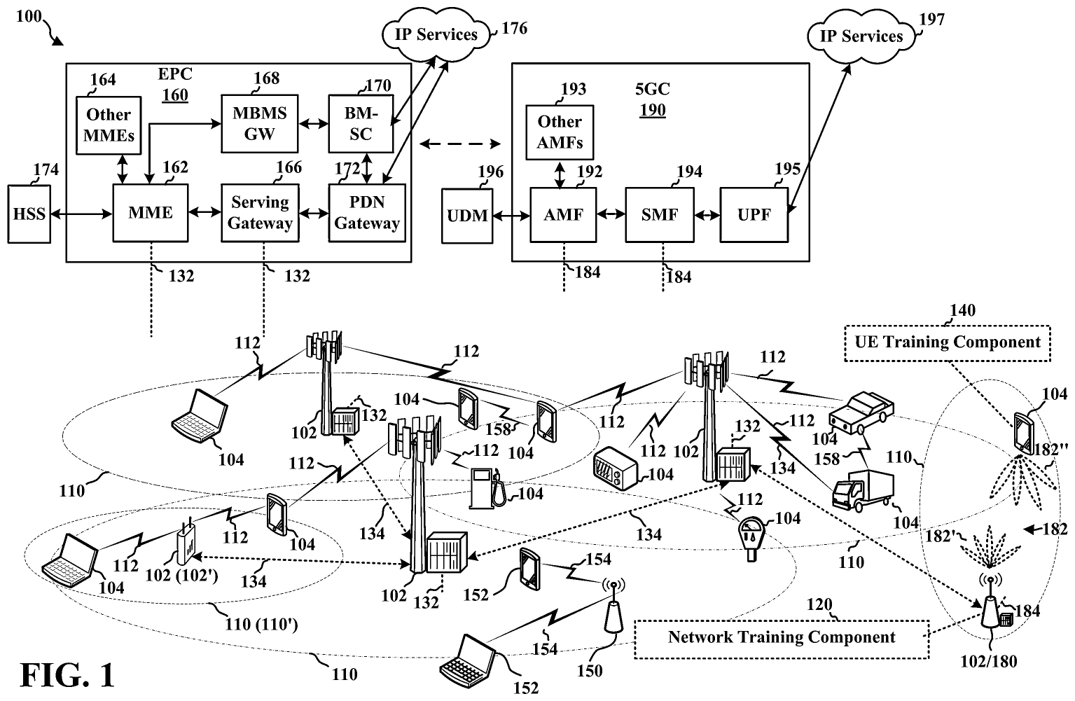

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network (e.g., a 5G Core (5GC) 190). The base stations 102 may include macrocells (high power cellular base station) and/or small cells (low power cellular base station). The macrocells include base stations. The small cells include femtocells, picocells, and microcells.

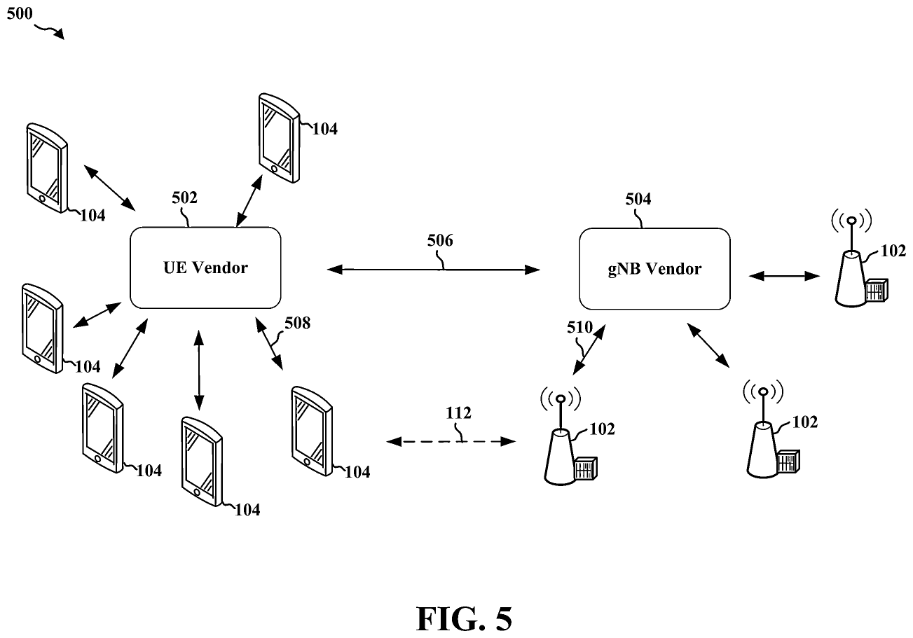

One or more of the UEs 104 may include a UE training component 140 for communicating with at least a UE vendor 502 of FIG. 5 to perform data collection and model training.

In an aspect, one or more of the base stations 102 may include a network training component 120 for communicating with at least a network entity vendor, such as gNB vendor 504 of FIG. 5 to perform data collection with UE 104 and model training.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The backhaul links 132 may be wired or wireless. The base stations 102 configured for 5G NR (collectively referred to as Next Generation RAN (NG-RAN)) may interface with 5GC 190 through backhaul links 184. The backhaul links 184 may be wired or wireless. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 112 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 112 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and a physical sidelink feedback channel (PSFCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

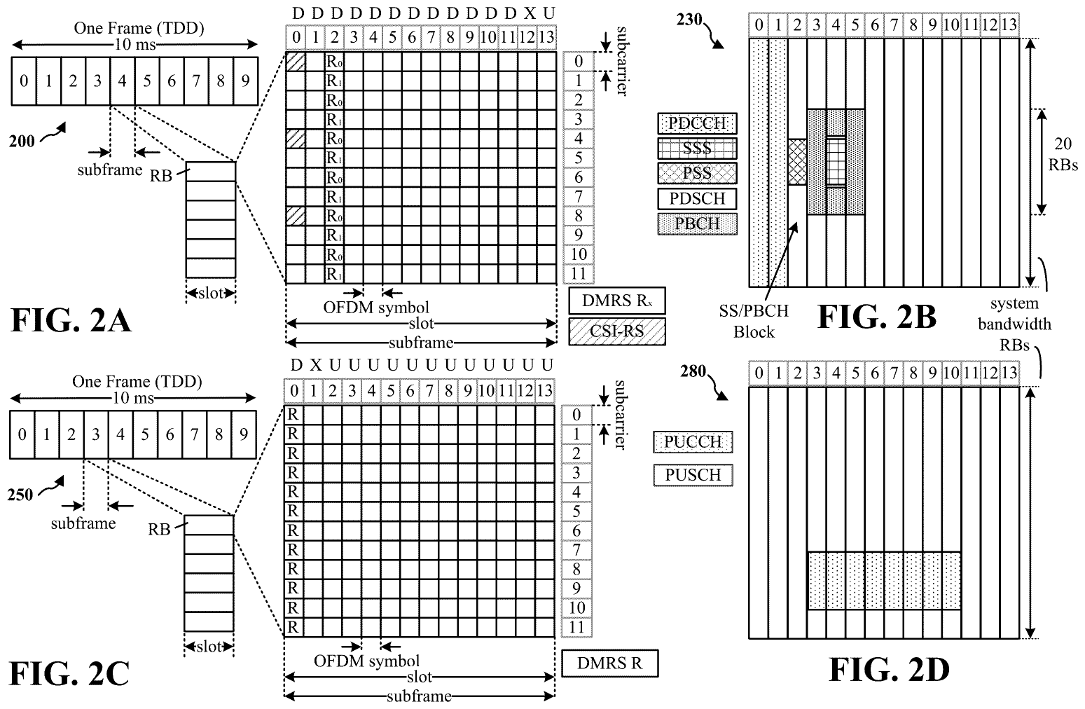

FIGS. 2A-2D are resource diagrams illustrating example frame structures and channels that may be used for uplink, downlink, and sidelink transmissions to a UE 104 including a CB mapping preference component 140. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2^{μ} slots/subframe. The subcarrier spacing and symbol length/duration are a function of the numerology. The subcarrier spacing may be equal to 2^{μ}*15 kHz, where y is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

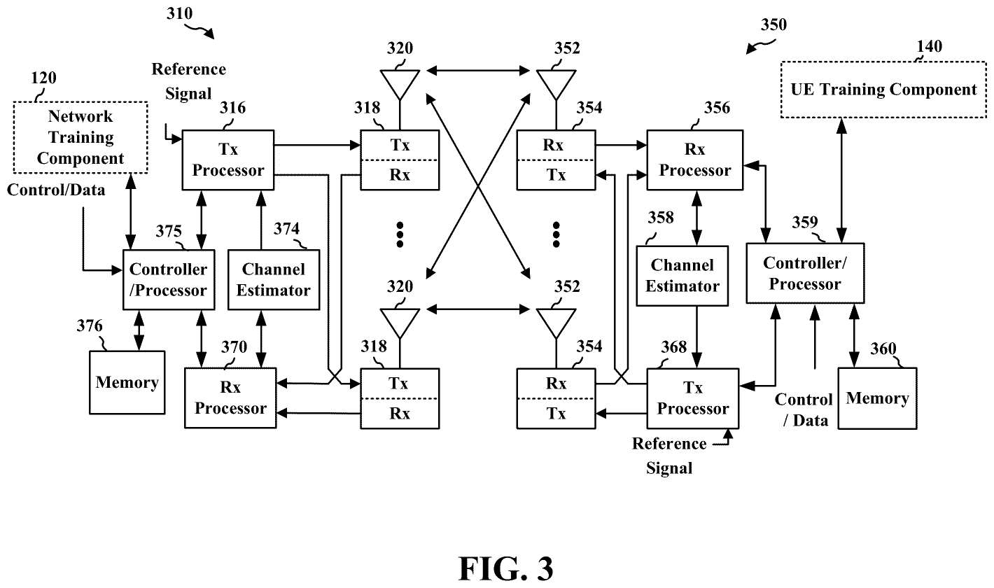

FIG. 3 is a block diagram of a base station/network entity vendor 310 in communication with a UE/UE vendor 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate an RF carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160 or 5GC 190. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the UE training component 140 of FIG. 1.

At least one of the Tx processor 316, the Rx processor 370, and the controller/processor 375 may be configured to perform aspects in connection with the network training component 120 of FIG. 1.

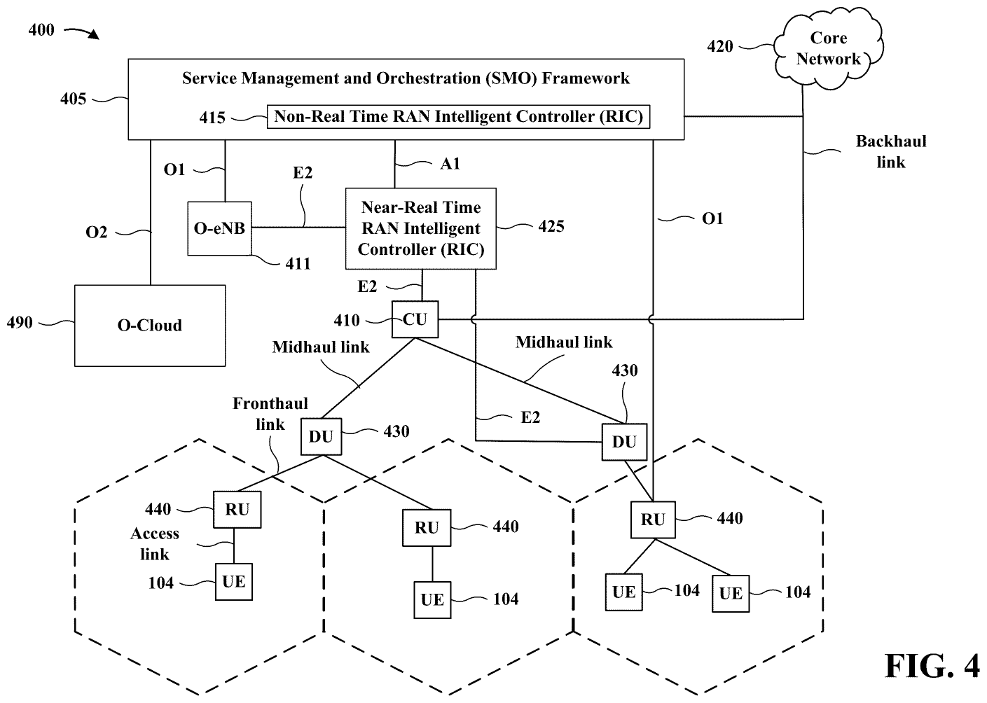

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

FIG. 5 is a diagram illustrating an example of an communication system including a UE vendor and a gNB vendor. For example, UE vendor 502 may serve a plurality of UEs, such as UE 104 of FIG. 1, and correspond to UE vendor 316 of FIG. 3. UE vendor 502 may be configured for data collection from the plurality of UEs 104 that are in direct communication. The plurality of UEs 104 may be linked with UE vendor 502 wirelessly or via a wired connection. UE vendor 502 may be directly and/or indirectly linked 506 to gNB vendor 504. The gNB vendor 504 may be linked directly and/or indirectly to a plurality of gNBs, such as base stations 102 of FIG. 1, and may correspond to network entity vendor 310 of FIG. 3. The UE vendor 502 and gNB vendor 504 may perform data collection and online/offline training for channel status information (CSI) feedback (CSF) compression for communications between UE(s) 104 and gNB(s) 102.

In an aspect, UE vendor 502 may initiate UE-based training for the plurality of UEs 104 that it is associated with. For example, UE vendor 502 may request UE(s) 104 to collect data for model training. In some instances, the request may occur via a UE Application operating on the UE(s) 104. In response to receiving the request, the UE(s) 104 may send, via communication link 112, the request to a gNB, such as base station 102 of FIG. 1, and the model manager for the gNB 102 to configure the UE 104 for training data collection. The model manager for the gNB 102 may correspond to gNB vendor 504.

In an aspect, UE vendor 502 may initiate model training and coordinate with gNB vendor 504. In another aspect, UE vendor 502 may perform area based training by directly sending a request to the gNB vendor 504 to initiate the model training. the gNB vendor 502 may request gNB(s) 102 to configure model training and select suitable UE(s) 104 for training data collection based on the UE type, UE capability, and user consent.

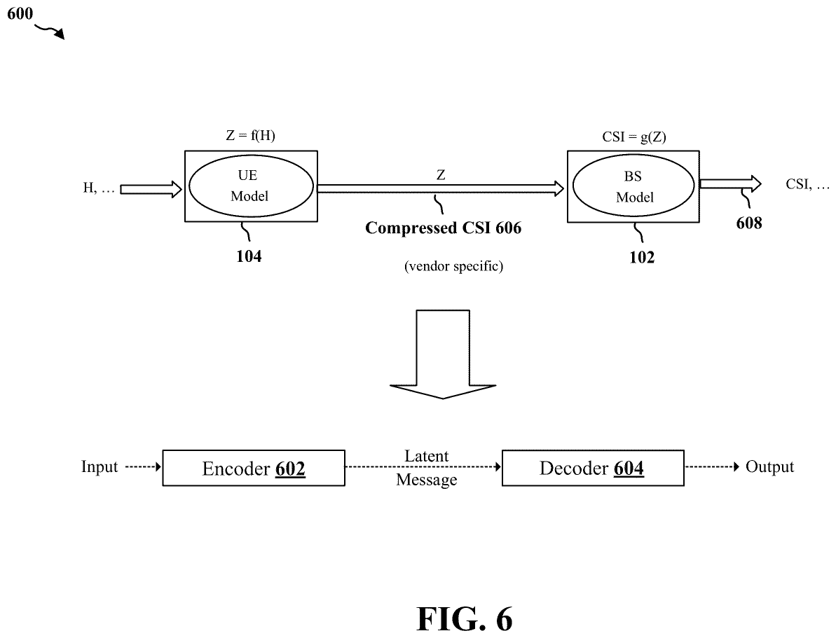

FIG. 6 illustrates a conceptual diagram 600 of CSF compression between a UE and a network entity in a wireless communication system. For example, the UE 104 may correspond to UE 104 of FIG. 1, and gNB 102 may correspond to base station 102 of FIG. 1.

For example, in cross-node machine language (ML), a neural network (NN) is split into two portions: the encoder 602 on a UE, such as UE 104 and the decoder 604 on a gNB, such as base station 102. The encoder output from the UE 104 is transmitted to the gNB 102 as an input to the decoder 604. In one example, the encoder 602 at a UE 104 outputs a compressed CSF 606, which is input to the decoder 604 at gNB 102. The decoder 604 at the gNB 102 outputs a reconstructed CSF 608, such as precoding vectors. In order to train the encoder 602 and the decoder 604, a UE vendor, such as UE vendor 502 of FIG. 5, may train both models using its own dataset, and share the trained decoder model with a gNB vendor, such as gNB vendor 504.

In an aspect, the decoder shared with the infra vendor may reveal or hint at the implementation detail of the UE modem due to the symmetry that typically exists between the encoder and the decoder. For example, if the encoder employs convolutional layers, the decoder employs the transpose convolutional layers correspondingly. To overcome this issue, the UE vendor 502 may share with the gNB vendor 504 the training set that contains expected (input, output) tuples for its trained decoder. Then, from gNB vendor 504 perspective, the learning of the decoder 604 becomes supervised learning using the training set created by the UE vendor 502. The supervised learning may correspond to knowledge distillation, where the decoder model trained by the UE vendor 502 becomes a teacher and the decoder model employed by the gNB vendor 504 becomes a student. Accordingly, the decoder model trained by the UE vendor 502 is not revealed to the gNB vendor 504. Hence, the architecture of the decoder model employed by the gNB vendor 504 is not the same as the architecture of the decoder model trained by the UE vendor 502.

In an aspect, the decoder 604 output may correspond to at least one of a downlink channel matrix (H), transmit covariance matrix, downlink precoders (V), interference covariance matrix (Rₙₙ), and raw vs. whitened downlink channel.

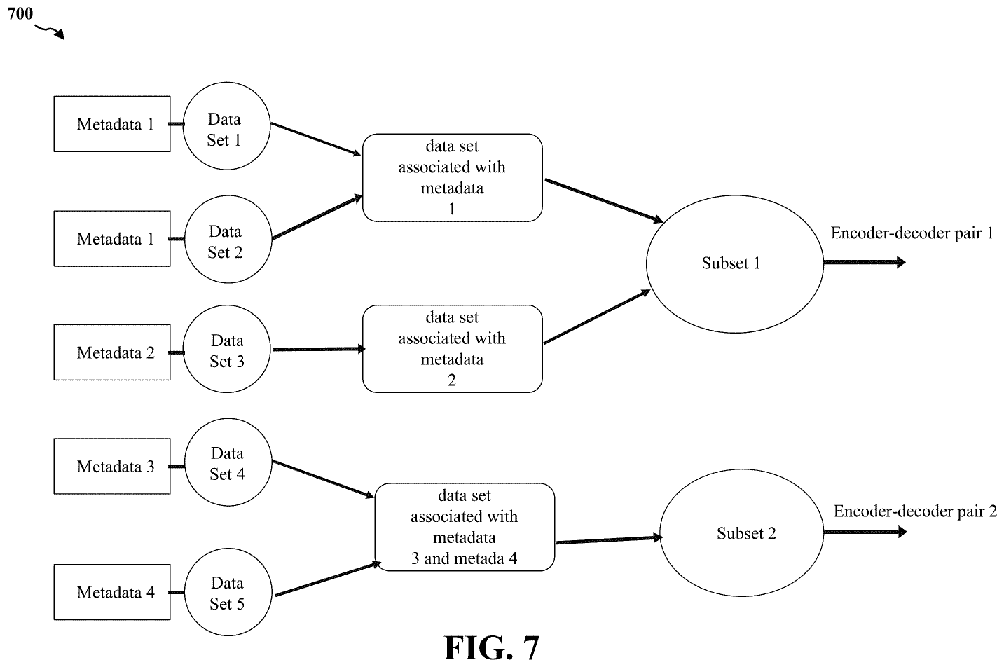

FIG. 7 illustrates a conceptual diagram 700 of an inner-loop in the UE vendor training for one encoder-decoder pair.

In an aspect, an access network, such as access network 100 of FIG. 1 may include one or more heterogeneous UEs (different baseband and RF implementation, different antennas, different OEMs), such as UEs 104, and heterogeneous channel statistics across cells. In this aspect, one encoder-decoder may not achieve a performance level above a certain threshold of acceptability across all the scenarios. In these instances, a UE 104 participating in data collection tags the collected data with the metadata that describes the scenario for data collection, which originate from both gNB(s) 102 and UE(s) 104. For example, metadata from gNB 102 may include gNB antenna configuration, CSI-RS beam configuration, etc. Further, gNB 102 metadata may be provided to the UE 104 in terms of “gNB meta-ID”, but without revealing any gNB implementation. Metadata from UE 104 may include UE antenna configuration, SNR, RSRP, delay spread, average delay, time stamp, etc. UE 104 may decompose the UE metadata into “UE meta-ID” that UE vendor does not desire to disclose to gNB vendor 504, and rest of the UE metadata.

In an aspect, at the UE server/UE vendor 502, the N sets of data are collected from multiple UEs 104 participating in the data collection. For example, UE server/UE vendor 502 may combine N sets of data into L (<N) data sets according to the associated metadata. The L data sets is further grouped into M (M<<L) subsets, based on UE types and channel statistics. The UE vendor 502 may train M encoder-decoder pairs, and obtain M training sets from M trained encoder-decoder pair to be shared with gNB vendor 504 by performing an inner-loop procedure M times as described further herein. In some instances, each of the M trained encoder-decoder is associated with one or more metadata. The association between M encoder-coder pairs and metadata allows gNB 102 to switch between the models during inference.

In an aspect, H_{raw} denotes the channel observed from the CSIRS channel; H corresponds to a processed form of H_{raw}, e.g. whitened channel. For example, H=f(H_{raw}, Rₙₙ), where Rₙₙ corresponds to an observed noise covariance matrix. In this implementation, UE 104 may desire to hide from the infra. Further, V may correspond to the ground truth of what the decoder aims to reconstruct, such as precoding vectors. The q_{ϕ} corresponds to an encoder, such as encoder 602 of FIG. 6 with z corresponding to a latent vector, e.g. compressed CSI and being calculated based on z=q_{ϕ}(H). The pe corresponds to a decoder, such as decoder 604 of FIG. 6 with \hat{V}=p_{θ}(z) corresponding to the reconstruction of V by the decoder 604.

In an aspect, a procedure for UE vendor driven offline training of cross-node ML may include the following steps. In a first step, UE vendor 502 trains an encoder-decoder pair (q_{ϕ}, p_{θ}) using the raw dataset stored at the UE server/vendor 502. In a second step, once the encoder-decoder pair is trained, UE vendor 502 generates the training set {(encoder ID, z, V)} by operating the encoder 602 using the UE vendor 502 raw dataset. For example, z corresponds to the encoder 602 output, e.g., a latent vector, while V corresponds to a desired decoder 604 output, e.g., a precoding vector. In a third step, UE vendor 502 provides the training set {(encoder ID, z, V)} to the gNB vendor 604.

In an aspect, another procedure for UE vendor driven offline training of cross-node ML may include the following steps. In a first step, on a server of UE vendor 502, the UE vendor 502 trains an encoder-decoder pair (q_{ϕ}, p_{θ}), using the UE vendor 502 raw dataset. In a second step, after the encoder-decoder pair is trained, UE vendor 502 generates the two training sets: the 1^{st} training set {(encoder ID, z, \hat{V}=p_{θ}(z))} by running the encoder 602 and decoder 604 using the UE vendor 502 raw dataset; and the 2^{nd} training set {(encoder ID, z+ϵ, p_{θ}(z+ϵ))} by perturbing the encoder 602 output by small vector and computing the corresponding decoder 604 output, with z corresponding to the encoder 602 output, V corresponding to the desired decoder 604 output, and V corresponding to the reconstruction of V by the decoder 604. In a third step, UE vendor 502 provides the two training sets to the gNB vendor 504.

In an aspect, another procedure for UE vendor driven offline training of cross-node ML may include the following steps. In a first step, on a server of UE vendor 502, the UE vendor 502 trains an encoder-decoder pair (q_{ϕ}, p_{θ}), using the UE vendor 502 raw dataset. In a second step, after the encoder-decoder pair is trained, UE vendor 502 generates the two training sets: the 1st training set {(encoder ID, z)} by running the encoder 602 using the UE vendor 502 raw dataset; and the 2^{nd} training set {(encoder ID, z+E)} by perturbing the encoder 602 output z in the first training set by a small vector E where z corresponds to the encoder 602 output. In a third step, UE vender 502 finds a substitute decoder f that approximates the found decoder p_{θ}, such that f produces the same or similar output as pe in response to the two training sets based on:

$${p}_{θ} ( z + ϵ ) = f ( z + ϵ ) and {p}_{θ} ( z ) = f ( z )$$

For example, UE vendor 502 may determine one substitute decoder 504 for each encoder ID. In a fourth step, UE vendor 502 provides the two training sets and the substitute decoder (encoder ID, f) to the gNB vendor 504.

In an aspect, gNB vendor 504 may train one or multiple decoders 604 based on the M sets of training sets. For example, gNB vendor 504 may train at least one of one decoder for all of M groups, one decoder per group (i.e. M decoders) or one decoder per several groups (i.e. less than M decoders). The decoder 604 may be gNB 102 specific or shared across multiple gNBs 102. Further, the gNB vendor 504 may determine the association between a specific gNB 102 or shared across multiple gNBs 102 based on at least one of the training sets {(encoder ID, z, V)}; the two training sets ({(encoder ID, z, \hat{V}=p_{θ}(z))}, {(encoder ID, z+ϵ, p_{θ}(z+ϵ))}); and the two training sets ({(encoder ID, z)} {(encoder ID, z+ϵ)}) and substitute decoders {(encoder ID, f)}.

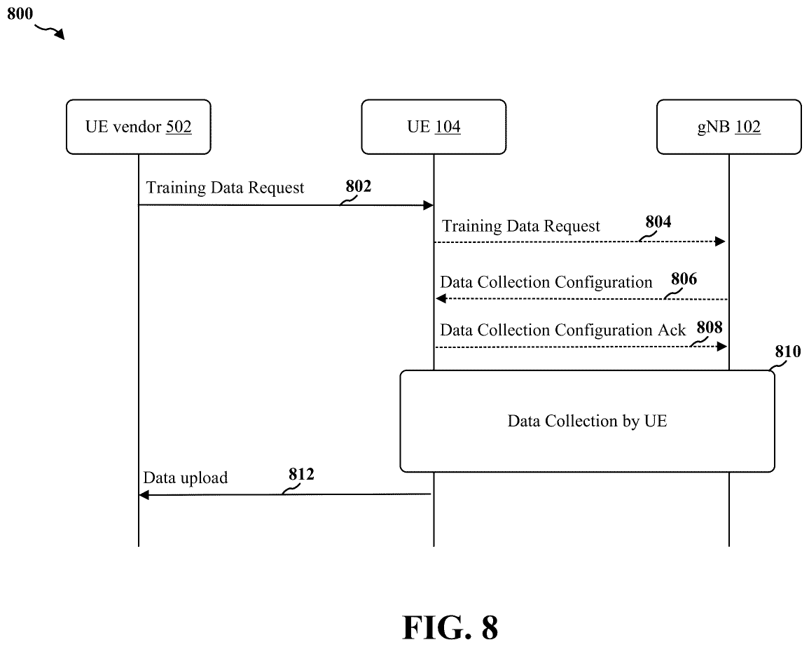

FIG. 8 is a message diagram 800 illustrating example messages for a data collection procedure for CSF compression. For example, diagram 800 illustrates messaging between a UE vendor, such as UE vendor 502 of FIG. 5, UE, such as UE 104 of FIG. 1, and a gNB, such as base station 102 of FIG. 1.

In an aspect, at step 802, UE vendor 502 may transmit a training data request to UE 104. In response to receiving the training data request, UE 104 may forward the training data request to gNB 102 at step 804. At step 806, gNB 102 may transmit a data collection configuration to UE 104 in response to receiving the training data request. For example, the information on the data collection configuration message may include at least one of a reference signal (RS), such as a CSI-RS, list for data collection, an area for data collection, a period for data collection, network side configuration, channel type, and process ID on data collection. In some instances, the configured RS may be dynamically activated/deactivated by gNB 102, such as, via media access control (MAC) control element (CE) or downlink control information (DCI). In some instances, the process ID may be a model ID which is already registered with MLF or the process ID may be used to generate a meta-id used in data uploading. In some instances, the signaling of the data collection configuration may correspond to reusing MDT configuration signaling or as information elements (IEs) into an RRCReconfiguration message.

At step 808, UE 104 may transmit a data collection configuration acknowledgement (ACK) to gNB 102 to indicate successful reception of the data collection configuration. Subsequently, at step 810, UE 104 may perform data collection with gNB 102. Upon completion of the data collection, UE 104 may upload the collected data to UE vendor 502 at step 812.

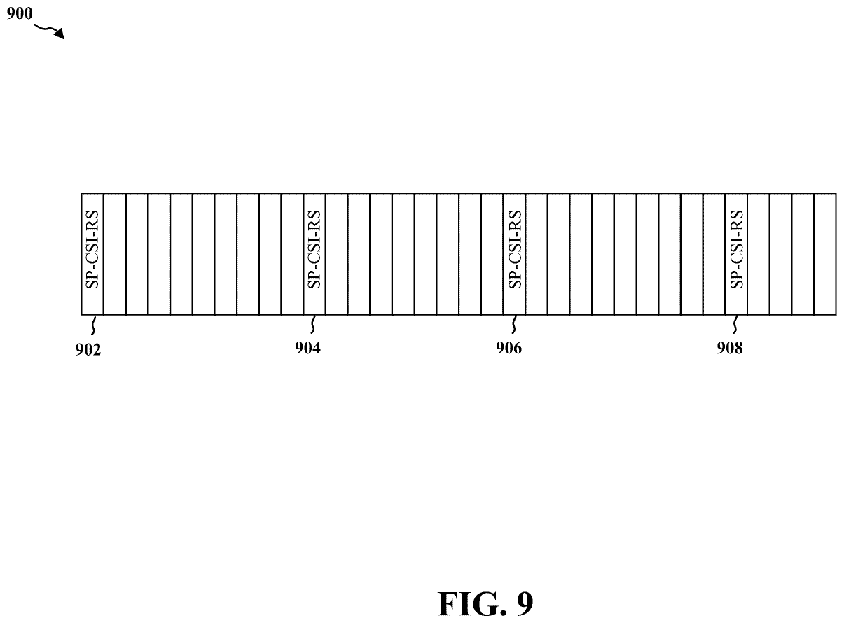

FIG. 9 is a conceptual diagram 900 illustrating an example frame structure for uploading data. For example, UE 104 may transmit the report of the data as illustrated in a number of instances 902, 904, 906, and 908 to UE vendor 502 in response to performing data collection between UE 104 and gNB 102.

In an aspect, UE report may include {H_raw, meta_id}, where H_raw is the channel estimation, in terms of RB index, port-index and Rx index; and Meta_id has following hierarchy and includes: data package ID (which may be generated using data process ID), cell/carrier ID, CSI-RS resource ID (which implicitly conveys the antenna mapping/layout), a list of records {record #1, record #2, etc.}, and GNSS. For example, each record includes time stamp, e.g., CSI-RS transmission instances or slot index, or measurement duration index (e.g., a record is based on a measurement of a certain duration, wherein the duration should be configured): gNB 102 may dynamically change the antenna mapping/layout, in which a time-stamp is required to label the reported data with the correct antenna mapping/layout. Additionally, each record includes SNR, SINR or RSRP; subcarrier spacing, and doppler/delay-spread measurement.

In an aspect, the format of H_raw and other additional data may include frequency domain resolution which corresponds to subcarriers, RB, or subbands; and/or eigen directions of H_raw is also reported as {H_raw, V_raw, meta_id} where V_raw frequency granularity is less than or equal to H_raw frequency granularity.

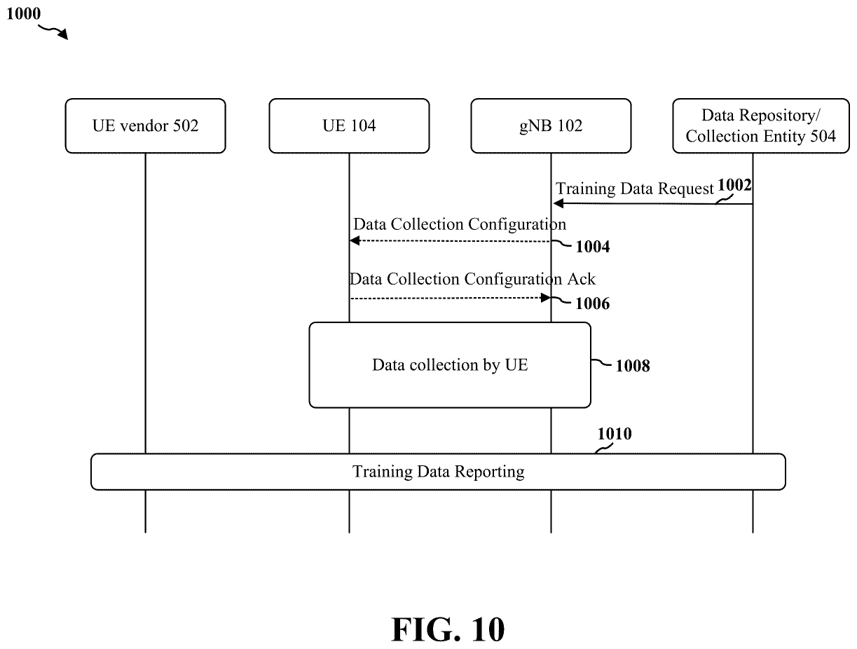

FIG. 10 is a message diagram 1000 illustrating example messages for a data collection procedure for CSF compression. For example, diagram 1000 illustrates messaging between a UE vendor, such as UE vendor 502 of FIG. 5, UE, such as UE 104 of FIG. 1, a gNB, such as base station 102 of FIG. 1, and a Data Repository/Collection Entity, such as gNB vendor 504 of FIG. 5.

In an aspect, at step 1002, the model/data repository 502 may transmit a training data request to gNB 102. At step 1004, gNB 1002 may transmit a data collection configuration to UE 104. For example, the information on the data collection configuration message may include at least one of a reference signal (RS), such as a CSI-RS, list for data collection, an area for data collection, a period for data collection, network side configuration, channel type, and process ID on data collection. In some instances, the configured RS may be dynamically activated/deactivated by gNB 102, such as, via media access control (MAC) control element (CE) or downlink control information (DCI). In some instances, the process ID may be a model ID which is already registered with MLF or the process ID may be used to generate a meta-id used in data uploading. In some instances, the signaling of the data collection configuration may correspond to reusing MDT configuration signaling or as information elements (IEs) into an RRCReconfiguration message.

At step 1006, UE 104 may transmit a data collection configuration ACK to gNB 102 in response to receiving the data collection configuration. In some instances, UE 104 may reject the data collection request and instead send a model training configuration reject message to gNB 102. Subsequently, at step 1008, UE 104 may perform data collection with gNB 102. At step 1010, the training data may be reported between UE vendor 502, UE 104, gNB 102, and model/data repository 504.

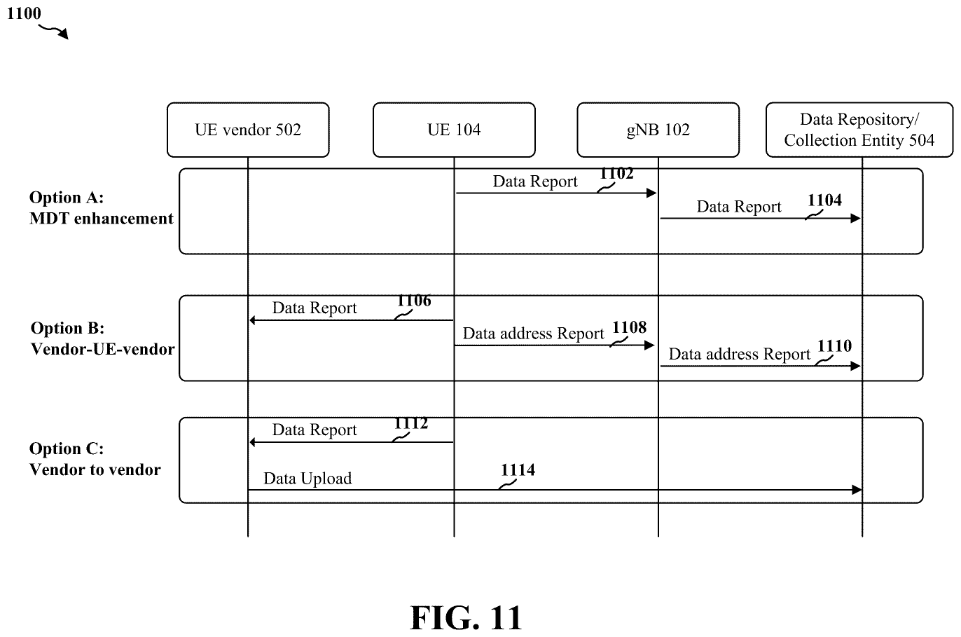

FIG. 11 is a message diagram 1100 illustrating example messages for step reporting training data during a data collection procedure for CSF compression. For example, diagram 1100 illustrates the specific messaging occurring during step 1010 of FIG. 10 between a UE vendor, such as UE vendor 502 of FIG. 5, UE, such as UE 104 of FIG. 1, a gNB, such as base station 102 of FIG. 1, and a Data Repository/Collection Entity, such as gNB vendor 504 of FIG. 5.

In an aspect, the reporting of the training data may be performed based on MDT enhancement. For example, at step 1102, UE 104 may transmit a data report to gNB 104. At step 1104, gNB 104 may forward the data report to the data repository/collection entity 504. In some instances, new IEs may be added into the MDT reporting signaling which may be file base or streaming based.

In an aspect, the report of the training data may be performed vendor-UE-vendor. For example, at step 1106, UE 104 may transmit the data report to UE vendor 502. Additionally, at step 1108, UE 104 may transmit the data address report to gNB 102. At step 1110, gNB 102 may forward the data address report to the data repository/collection entity 504. In some instances, UE 104 sends data to the UE server corresponding to UE vendor 502 due to limited memory at UE 104, and UE 104 may in turn provide an address for the gNB vendor 504 to download the data. Alternatively, UE 104 may directly report the data to the data repository/collection entity 504.

In an aspect, report of the training data may be performed vendor to vendor. For example, at step 1112, UE 104 may transmit the data report to UE vendor 502. At step 1114, UE vendor 502 may upload the data received from the data report to the data repository/collection entity 504. In some instances, UE vendor 502 may directly report gNB vendor 504 with proprietary protocol.

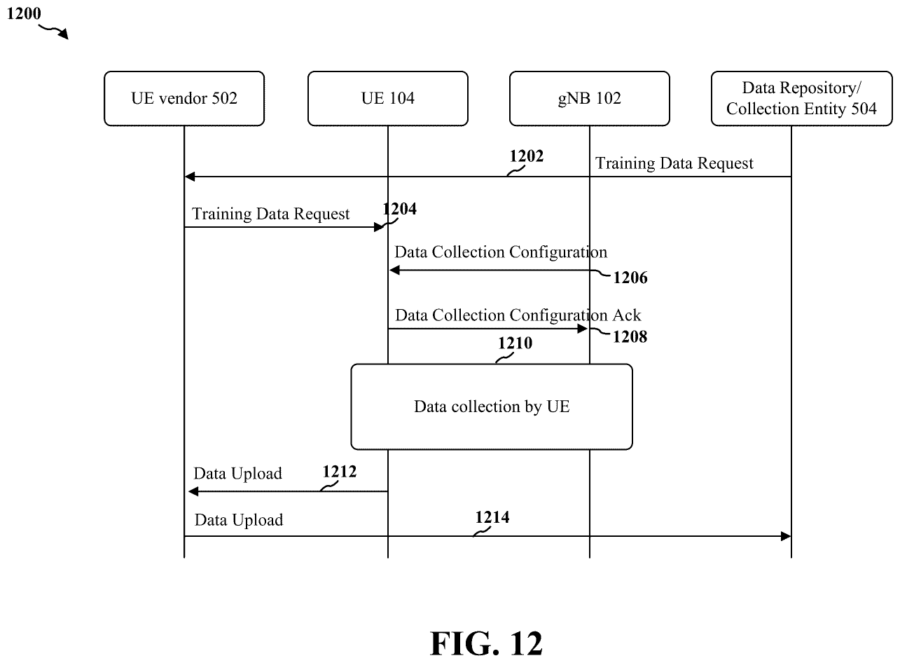

FIG. 12 is a message diagram 1200 illustrating example messages for a data collection procedure for CSF compression. For example, diagram 1200 illustrates messaging between a UE vendor, such as UE vendor 502 of FIG. 5, UE, such as UE 104 of FIG. 1, a gNB, such as base station 102 of FIG. 1, and a Data Repository/Collection Entity, such as gNB vendor 504 of FIG. 5.

In an aspect, at step 1202, the data report to the data repository/collection entity 504 may send a training data request to UE vendor 502. At step 1204, UE vendor 502 may forward the training data request to UE 104. At step 1206, gNB 102 may transmit a data collection configuration to UE 104. For example, the information on the data collection configuration message may include at least one of a RS, such as a CSI-RS, list for data collection, an area for data collection, a period for data collection, network side configuration, channel type, and process ID on data collection. In some instances, the configured RS may be dynamically activated/deactivated by gNB 102, such as, via MAC CE or DCI. In some instances, the process ID may be a model ID which is already registered with MLF or the process ID may be used to generate a meta-id used in data uploading. In some instances, the signaling of the data collection configuration may correspond to reusing MDT configuration signaling or as IEs into an RRCReconfiguration message.

At step 1208, UE 104 may transmit a data collection configuration ACK to gNB 102 in response to receiving the data collection configuration. Subsequently, at step 1210, UE 104 may perform data collection with gNB 102. At step 1212, the data may be uploaded to UE vendor 502. At step 1214, UE vendor 502 may upload the data to data repository collection entity 504.

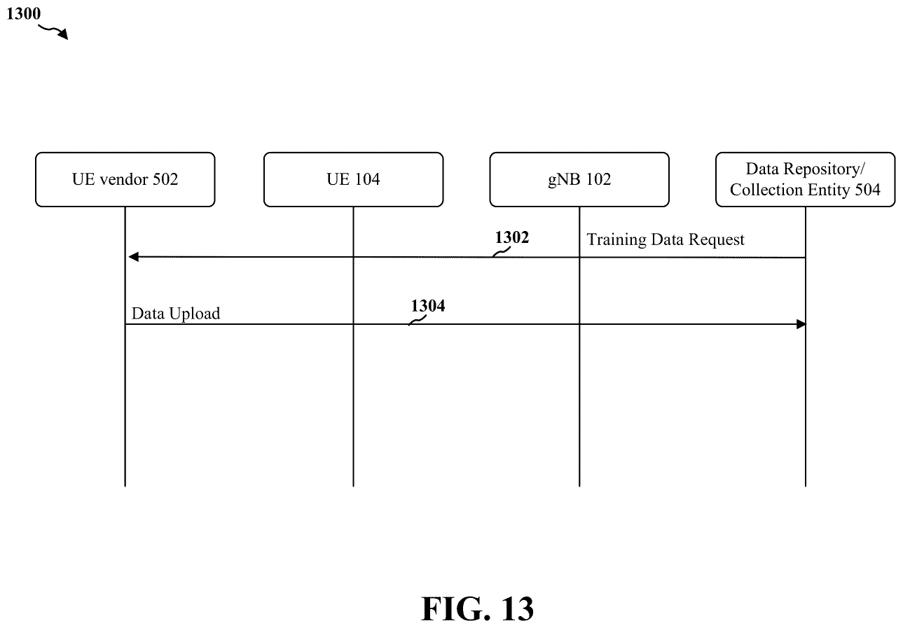

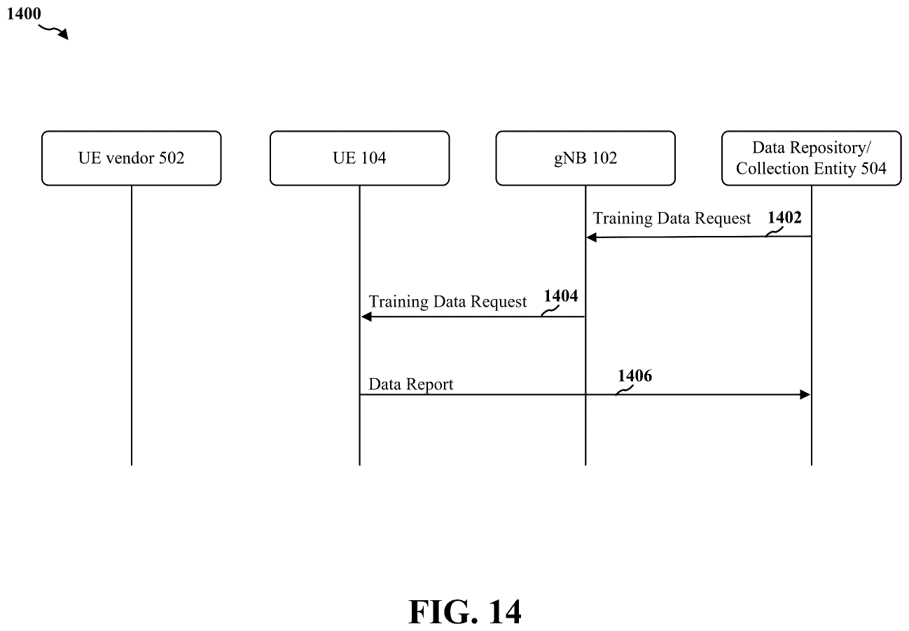

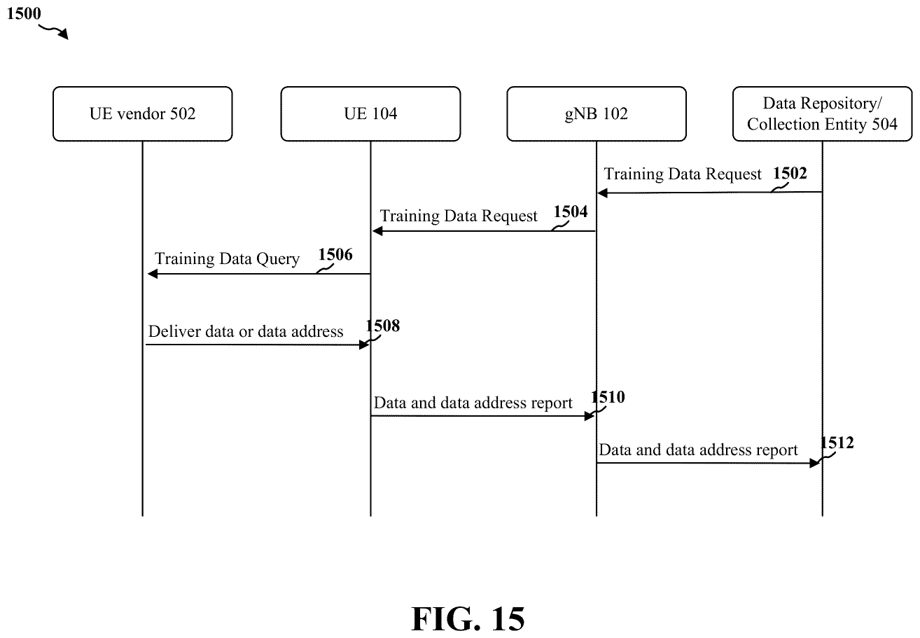

FIGS. 13-15 illustrate example messages for requesting existing data upload to a repository. For example, diagrams 1300, 1400, and 1500 illustrate messaging between a UE vendor, such as UE vendor 502 of FIG. 5, UE, such as UE 104 of FIG. 1, a gNB, such as base station 102 of FIG. 1, and a data repository/collection entity, such as gNB vendor 504 of FIG. 5.

In an aspect, message diagram 1300 illustrates a sideline in which a repository, such as data repository/collection entity 504 may communicate with a UE server of UE vendor 502 directly via proprietary protocol. For example, at step 1302, data repository/collection entity 504 may send a training data request to UE vendor 502. At step 1304, UE vendor 502 may send a data upload to data repository/collection entity 504 in response to the training data request.

In an aspect, message diagram 1400 illustrates an instance in which no sideline exists between data repository/collection entity 504 and UE vendor 502. For example, at step 1402, data repository/collection entity 504 may send a training data request to gNB 102. At step 1404, gNB 102 may forward the training data request 1404 to UE 104. At step 1406, UE 104 may communicate the data report to data repository/collection entity 504.

In an aspect, message diagram 1500 illustrates another instance in which no sideline exists between data repository/collection entity 504 and UE vendor 502. For example, at step 1502, data repository/collection entity 504 may send a training data request to gNB 102. At step 1504, gNB 102 may forward the training data request 1504 to UE 104. At step 1506, UE 104 may send a training data query to UE vendor 502. At step 1508, UE vendor 502 may send a data or data address to UE 104. At step 1510, UE 104 may send the data and data address report to gNB 102. At step 1512, gNB 102 may send the data and data address report to data repository/collection entity 504.

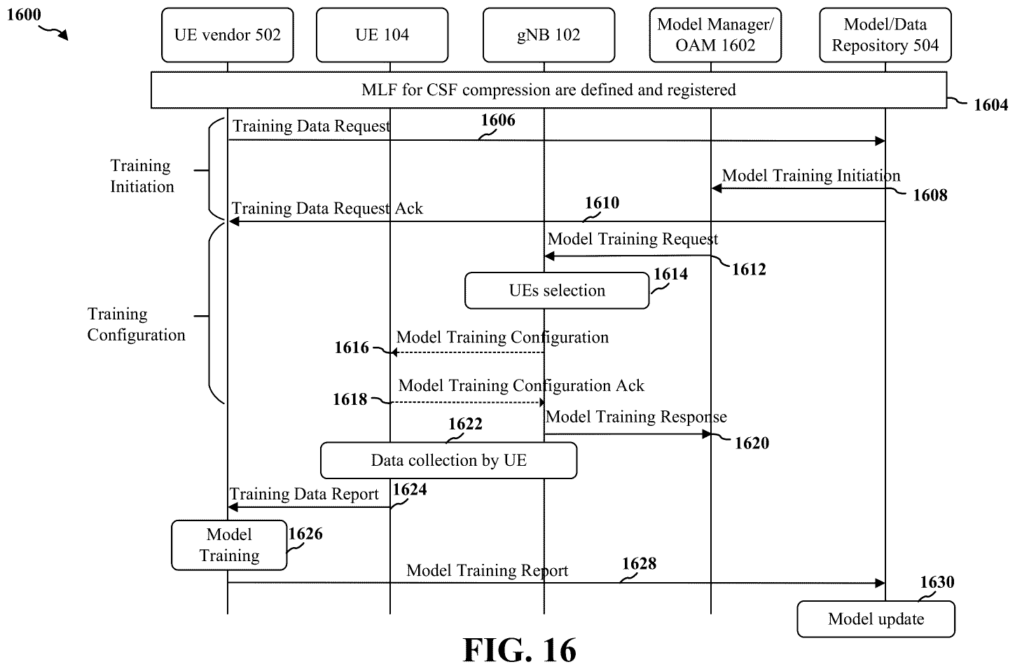

FIG. 16 is a message diagram 1600 illustrating example messages for a data collection procedure and offline model training for CSF compression using area based training at a UE. For example, diagram 1700 illustrates messaging between a UE vendor, such as UE vendor 502 of FIG. 5, UE, such as UE 104 of FIG. 1, a gNB, such as base station 102 of FIG. 1, model manager/OAM 1602, and model/data repository 504, both of which are associated with and/or are part of gNB vendor 504 of FIG. 5.

In an aspect, at step 1604, the MLF for CSF compression are defined and registered across the UE vendor 502, UE 104, gNB 102, model manager/OAM 1602, and model/data repository 504. For example, UE vendor 502 registers its CSF model to the network, such gNB 102 and/or gNB vendor 504. In some instances, registering includes Model ID or Model Structure (MS) ID; list of Parameter Set (PS) ID; applicable scenario for each PS which includes area, configuration, and UE type; and an applicable scenario of each model if multiple models are registered. For example, model training is initiated by UE vendor 502. In some instances, model training is coordinated by model manager/OAM 1602 which may correspond to an OAM, RIC (ORAN defined network entity, intelligent network controller), CU-XP, or gNB, such as gNB 102 depending on the deployment scenario and use case.

In instances of area based training, UE vendor 502 directly sends request to network side server, e.g., Model/Data Repository (MR) 504 corresponding to gNB vendor 504. For example, the MR 504 requests model manager 1602 to initiate the model training. Model manager 1602 requests gNB 102 to configure model training. Subsequently, gNB 102 selects suitable UEs 104 for training data collection, based on: UE type, UE capability, user consent. For example, at step 1606, UE vendor 502 may send a training data request to model/data repository 504 as part of a training initiation procedure. In model training configuration, the network, such gNB 102, sends metadata for model training and information on data collection. For example, information on data collection may include RS (e.g., CSI-RS) list for data collection where the configured RS may be dynamically activated/deactivate by gNB e.g., via MAC CE or DCI; an area for data collection; and a period for data collection. In some instances, metadata may include NM ID (associated with network side mode ID) where data of different NM IDs may be used for model training separately, network side configuration, and additional information, such as, channel type. In some instances, signaling may include reuse of MDT configuration signaling where the configuration information is added as IEs into a RRCReconfiguration message, or a new signaling procedure.

At step 1608, model/data repository 504 may send a model training initiation message to model manager/OAM 1602. At step 1610, model/data repository 504 may send a training data request ACK to UE vendor 502 in response to receiving the training data request at step 1606. At step 1612, model manager/OAMA 1602 transmit a model training request 1612 to gNB 102. At step 1614, gNB 102 may perform UEs selection, and at step 1616, send a model training configuration to UE 104. At step 1618, UE 104 may transmit a model training configuration ACK to gNB 102. At step 1620, gNB 102 sends the model training response to model manager/OAM 1602.

For example, UE 104 collects data based on the configuration received. The collected data is uploaded to UE vendor 502 server with additional information including a timestamp described in terms of either absolute time, relative time, or SFN+timeslot+(optionally) symbol; location information, such as GNSS if available and radio fingerprint: RSRP/RSRQ measurement of serving cell and neighbor cells; and metadata such as RS type, ID and NM_ID. In some instances, the model training may be based on previously collected data without the metadata. The configuration information received may be used as metadata and reported to UE vendor 502 server. The real data collection and report may be skipped in this instance. At step 1622, UE 104 performs data collection. At step 1624, UE 104 reports the training data to UE vendor 502 upon performing the data collection. At step 1626, UE vendor 502 performs model training upon receiving the training data report.

For example, the model training report may be directly uploaded to model/data repository 504 or the data may be distilled for gNB 102 to derive a base station model. If the data is distilled, UE vendor 502 generates some distilled data {Z, CSI} for the trained base station model and gNB vendor 504 may derive its model based on the data. Upon completion of the model training, UE vendor 502 may send a model training report to model/data repository 504 at step 1628. Upon reception of the model training report, model/data repository 504 performs model updating at step 1630.

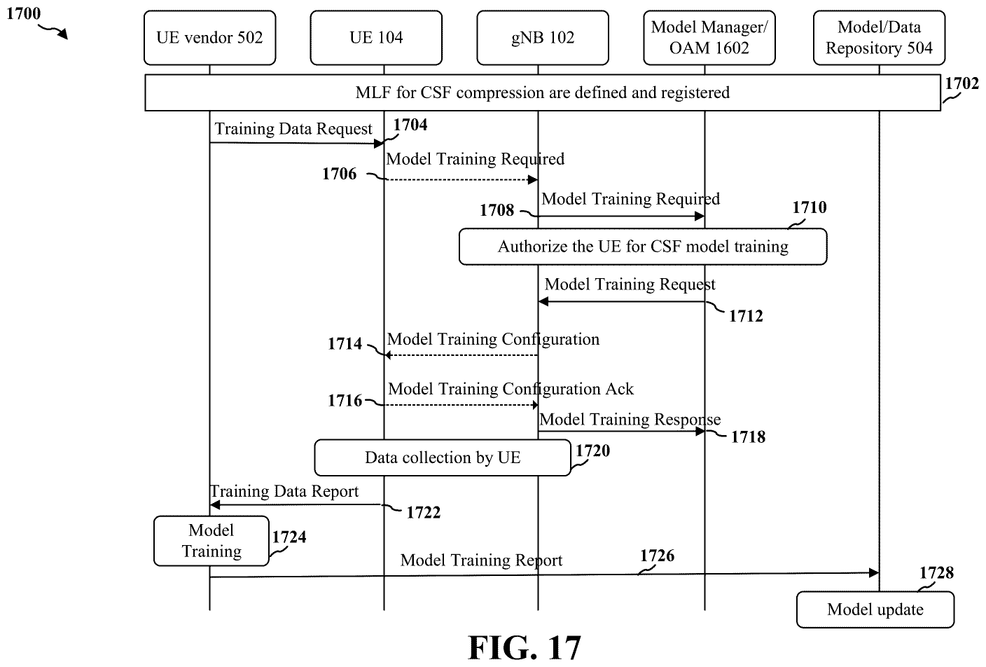

FIG. 17 is a message diagram 1700 illustrating example messages for a data collection procedure and offline model training for CSF compression using UE based configuration at a UE. For example, diagram 1700 illustrates messaging between a UE vendor, such as UE vendor 502 of FIG. 5, UE, such as UE 104 of FIG. 1, a gNB, such as base station 102 of FIG. 1, model manager/OAM 1602, and model/data repository 504, both of which are associated with and/or are part of gNB vendor 504 of FIG. 5.

In an aspect, at step 1702, the MLF for CSF compression are defined and registered across the UE vendor 502, UE 104, gNB 102, model manager/OAM 1602, and model/data repository 504. For example, UE vendor 502 registers its CSF model to the network, such gNB 102 and/or gNB vendor 504. In some instances, registering includes Model ID or Model Structure (MS) ID; list of Parameter Set (PS) ID; applicable scenario for each PS which includes area, configuration, and UE type; and an applicable scenario of each model if multiple models are registered. For example, model training is initiated by UE vendor 502. In some instances, model training is coordinated by model manager/OAM 1602 which may correspond to an OAM, RIC (ORAN defined network entity, intelligent network controller), CU-XP, or gNB, such as gNB 102 depending on the deployment scenario and use case.

In instances of UE 104 based training, UE vendor 502 requests UE 104 to collect data for model training, such as, via a UE App. UE 104 sends the request to gNB 102 and model manager 1602 for gNB 102 to configure UE 104 for training data collection. For example, at step 1704, UE vendor 504 may send a training data request to UE 104. At step 1706, UE 104 may transmit a model training required message to gNB 102. At step 1708, gNB 102 may forward the model training required message to model manager/OAM 1602. In model training configuration, the network, such gNB 102, sends metadata for model training and information on data collection. For example, information on data collection may include RS (e.g., CSI-RS) list for data collection where the configured RS may be dynamically activated/deactivate by gNB e.g., via MAC CE or DCI; an area for data collection; and a period for data collection. In some instances, metadata may include NM ID (associated with network side mode ID) where data of different NM IDs may be used for model training separately, network side configuration, and additional information, such as, channel type. In some instances, signaling may include reuse of MDT configuration signaling where the configuration information is added as IEs into a RRCReconfiguration message, or a new signaling procedure.

At step 1710, gNB 102 and model manager/OAM 1602 may authorize the UE(s) 104 for CSF model training. Upon completion of the authorization, model manager/OAM 1602 may send a model training request to gNB 102 at step 1712. At step 1714, gNB 102 may transmit a model training configuration to UE 104. At step 1716, UE 104 may transmit a model training configuration ACK to gNB 102 in response to receiving the model training configuration message. At step 1718, gNB 102 sends a model training response to model manager/OAM 1602.

For example, UE 104 collects data based on the configuration received. The collected data is uploaded to UE vendor 502 server with additional information including a timestamp described in terms of either absolute time, relative time, or SFN+timeslot+(optionally) symbol; location information, such as GNSS if available and radio fingerprint: RSRP/RSRQ measurement of serving cell and neighbor cells; and metadata such as RS type, ID and NM_ID. In some instances, the model training may be based on previously collected data without the metadata. The configuration information received may be used as metadata and reported to UE vendor 502 server. The real data collection and report may be skipped in this instance. At step 1720, UE 104 performs data collection. At step 1722, UE 104 sends a training data report to UE vendor 502. At step 1724, UE vendor 502 performs model training.

For example, the model training report may be directly uploaded to model/data repository 504 or the data may be distilled for gNB 102 to derive a base station model. If the data is distilled, UE vendor 502 generates some distilled data {Z, CSI} for the trained base station model and gNB vendor 504 may derive its model based on the data. At step 1726, UE vendor 502 sends a model training report to model/data repository 504. At step 1728, model/data repository 504 performs a model update upon receiving the model training report.

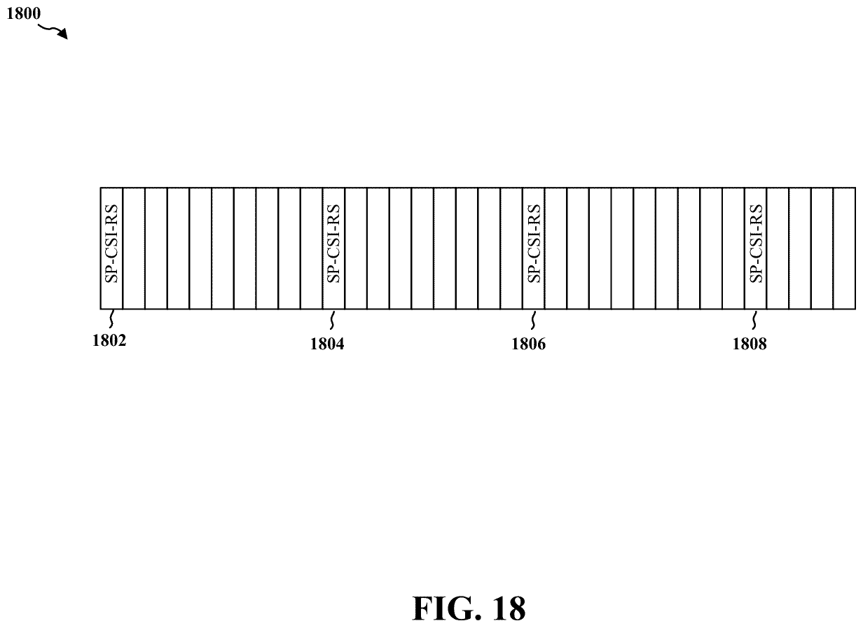

FIG. 18 is a conceptual diagram 1800 illustrating an example frame structure for uploading data. For example, UE 104 may transmit the report of the data as illustrated in a number of instances 1802, 1804, 1806, and 1808 to UE vendor 502 in response to performing data collection between UE 104 and gNB 102.

In an aspect, UE report may include {H_raw, meta_id}, where H_raw is the channel estimation, in terms of RB index, port-index and Rx index; and Meta_id has following hierarchy and includes: Cell ID; CSI-RS resource ID (implicitly conveying the antenna mapping/layout); a list of records {recorde #1, record #2, etc}, where each records includes a time stamp, e.g., CSI-RS transmission instances or slot index, or measurement duration index (e.g., a record is based on a measurement of a certain duration, wherein the duration should be configured): gNB 102 may dynamically change the antenna mapping/layout, so time-stamp is needed to label the reported data with correct antenna mapping/layout; SNR, SINR or RSRP; subcarrier spacing; and Doppler/delay-spread measurement.

In an aspect, the format of H_raw and other additional data may include frequency domain resolution which corresponds to subcarriers, RB, or subbands; and/or eigen directions of H_raw is also reported as {H_raw, V_raw, meta_id} where V_raw frequency granularity is less than or equal to H_raw frequency granularity.

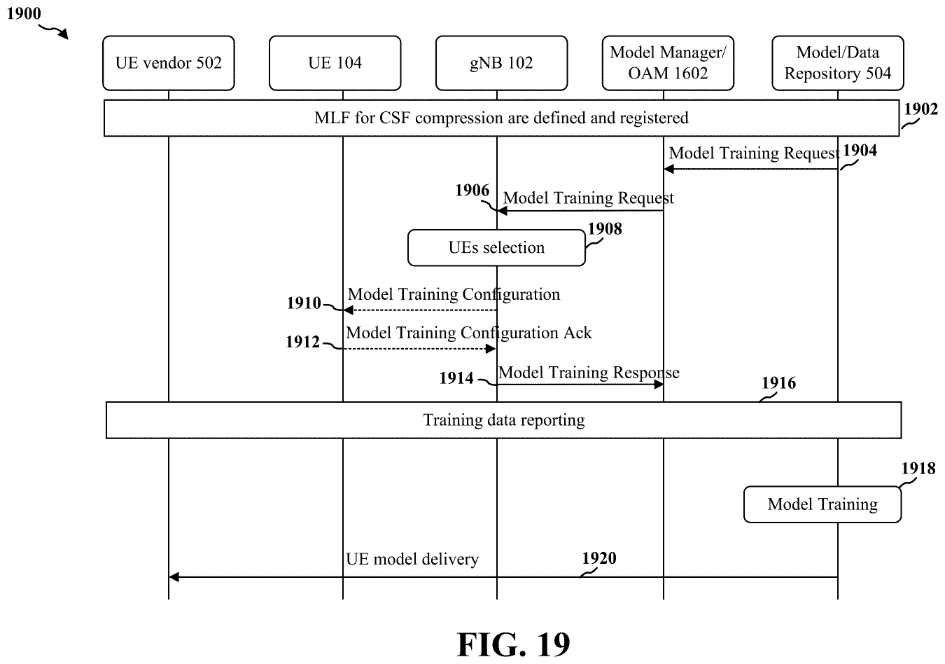

FIG. 19 is a message diagram 1900 illustrating example messages for a data collection procedure and offline model training for CSF compression using area based training at a UE. For example, diagram 1900 illustrates messaging between a UE vendor, such as UE vendor 502 of FIG. 5, UE, such as UE 104 of FIG. 1, a gNB, such as base station 102 of FIG. 1, model manager/OAM 1602, and model/data repository 504, both of which are associated with and/or are part of gNB vendor 504 of FIG. 5.

In an aspect, at step 1902, the MLF for CSF compression are defined and registered across the UE vendor 502, UE 104, gNB 102, model manager/OAM 1602, and model/data repository 504. For example, UE vendor 502 registers its CSF model to the network, such gNB 102 and/or gNB vendor 504. In some instances, registering includes Model ID or Model Structure (MS) ID; list of Parameter Set (PS) ID; applicable scenario for each PS which includes area, configuration, and UE type; and an applicable scenario of each model if multiple models are registered. For example, model training is initiated by UE vendor 502. In some instances, model training is coordinated by model manager/OAM 1602 which may correspond to an OAM, RIC (ORAN defined network entity, intelligent network controller), CU-XP, or gNB, such as gNB 102 depending on the deployment scenario and use case.

At step 1904, model/data repository 504 may send a model training request to model manager/OAM 1602, At step 1906, model manager/OAM 1602 forwards the model training request to gNB 102. At step 1908, gNB 102 performs UE selection. At step 1910, gNB 102 transmits a model training configuration to UE 104. At step 1912, UE 104 transmits model training configuration ACK to gNB 102. At step 1914, gNB 102 sends a model training response to model manager/OAM 1602. At step 1916, training data reporting occurs. At step 1918, model/data repository 504 performs model training. At step 1920, model/data repository 504 sends the UE model delivery to UE vendor 502.

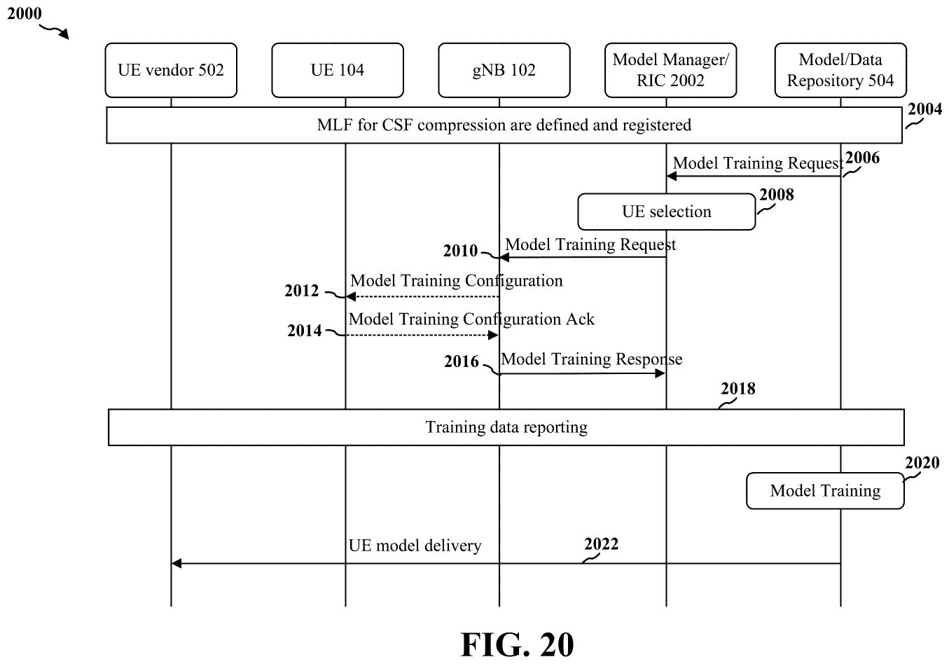

FIG. 20 is a message diagram 2000 illustrating example messages for a data collection procedure and offline model training for CSF compression using UE based training at a UE. For example, diagram 2000 illustrates messaging between a UE vendor, such as UE vendor 502 of FIG. 5, UE, such as UE 104 of FIG. 1, a gNB, such as base station 102 of FIG. 1, model manager/RIC 2002, and model/data repository 504, both of which are associated with and/or are part of gNB vendor 504 of FIG. 5.

In an aspect, at step 2004, the MLF for CSF compression are defined and registered across the UE vendor 502, UE 104, gNB 102, model manager/RIC 2002, and model/data repository 504. For example, UE vendor 502 registers its CSF model to the network, such gNB 102 and/or gNB vendor 504. In some instances, registering includes Model ID or Model Structure (MS) ID; list of Parameter Set (PS) ID; applicable scenario for each PS which includes area, configuration, and UE type; and an applicable scenario of each model if multiple models are registered. For example, model training is initiated by UE vendor 502. In some instances, model training is coordinated by model manager/RIC 2002 which may correspond to an OAM, RIC (ORAN defined network entity, intelligent network controller), CU-XP, or gNB, such as gNB 102 depending on the deployment scenario and use case.

At step 2006, model/data repository 504 may send a model training request to model manager/RIC 2002, At step 2008, model manager/RIC 2002 performs UE selection. At step 2010, model manager/RIC 2002 forwards the model training request to gNB 102. At step 2012, gNB 102 transmits a model training configuration to UE 104. At step 2014, UE 104 transmits model training configuration ACK to gNB 102. At step 2016, gNB 102 sends a model training response to model manager/RIC 2002. At step 2018, training data reporting occurs. At step 2020, model/data repository 504 performs model training. At step 2022, model/data repository 504 sends the UE model delivery to UE vendor 502.

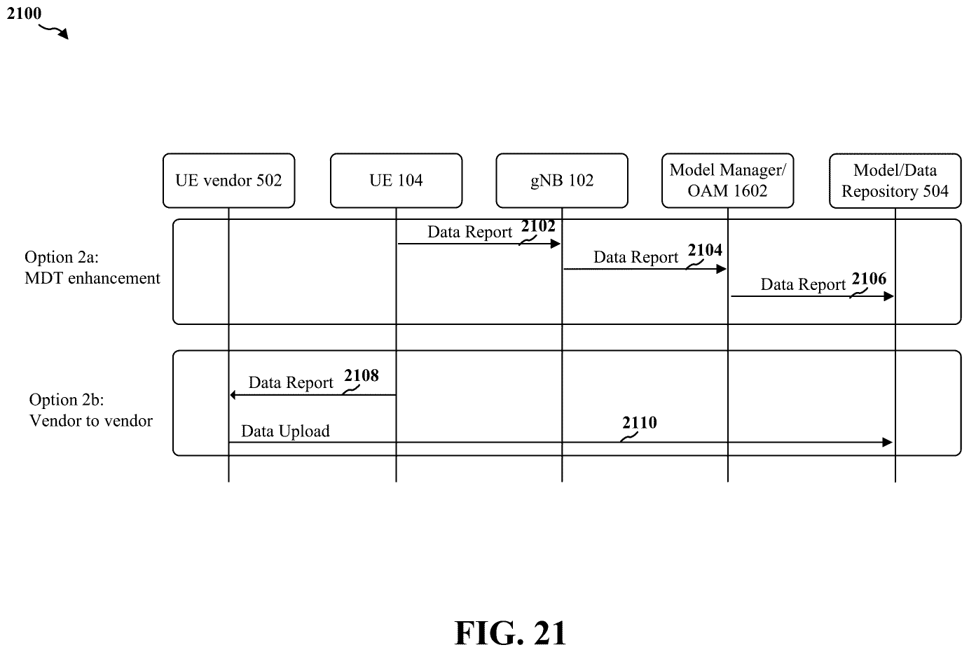

FIG. 21 is a message diagram 2100 illustrating example messages for step reporting training data during a data collection procedure for CSF compression. For example, diagram 2100 illustrates the specific messaging occurring during steps 1916 of FIG. 19 and step 2018 of FIG. 20 between a UE vendor, such as UE vendor 502 of FIG. 5, UE, such as UE 104 of FIG. 1, a gNB, such as base station 102 of FIG. 1, model manager 1602, and a model/data repository, such as gNB vendor 504 of FIG. 5. In an example, the data to report may include a channel matrix, UE model information such as MS ID and PS ID, and NM ID and timestamp.

In an aspect, the reporting of the training data may be performed based on MDT enhancement. For example, at step 2102, UE 104 may transmit a data report to gNB 104. At step 2104, gNB 104 may forward the data report to the model manager 1602. In some instances, new IEs may be added into the MDT reporting signaling which may be file base or streaming based. At step 2106, model manager 1602 may forward the data report to model/data repository 504.

In an aspect, report of the training data may be performed vendor to vendor. For example, at step 2108, UE 104 may transmit the data report to UE vendor 502. At step 2110, UE vendor 502 may upload the data received from the data report to the model/data repository 504. In some instances, UE vendor 502 may directly report gNB vendor 504 with proprietary protocol.

In an aspect, UE collected data may be used to train both models at the network side. For example, data collection may occur by UE vendor 502 similar to the messaging as described in FIGS. 16 and 17. UE vendor 502 uploads collected data to gNB vendor 504 based on steps 2108 and 2110 of FIG. 21. Further, model training may occur similar to the message as described in FIGS. 19 and 20. The gNB vendor 504 sends UE model to UE vendor 502 similar to the messaging as described in FIGS. 19 and 20.

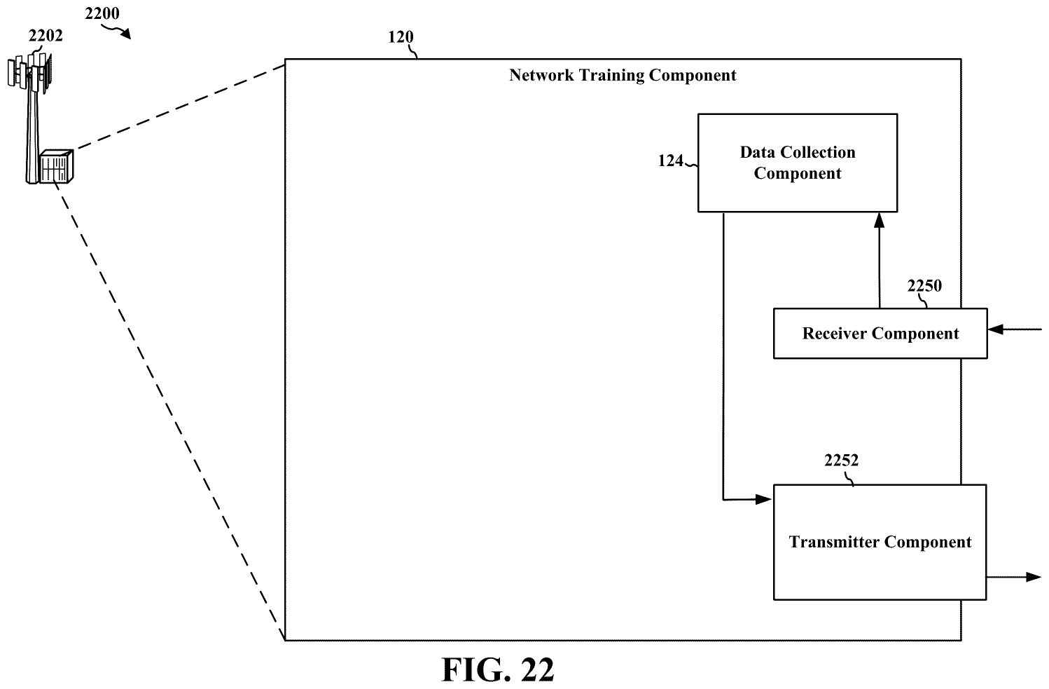

FIG. 22 is a conceptual data flow diagram 2200 illustrating the data flow between different means/components in an example base station 2202, which may be an example of the base station 102 including the network training component 120. The network training component 120 may include the data collection component 124.

The base station 2202 may also include a receiver component 2250 and a transmitter component 2252. The receiver component 2250 may include, for example, a RF receiver for receiving the signals described herein. The transmitter component 2252 may include for example, an RF transmitter for transmitting the signals described herein. In some implementations, the receiver component 2250 and the transmitter component 2252 may be co-located in a transceiver such as the Tx/Rx 318 in FIG. 3.

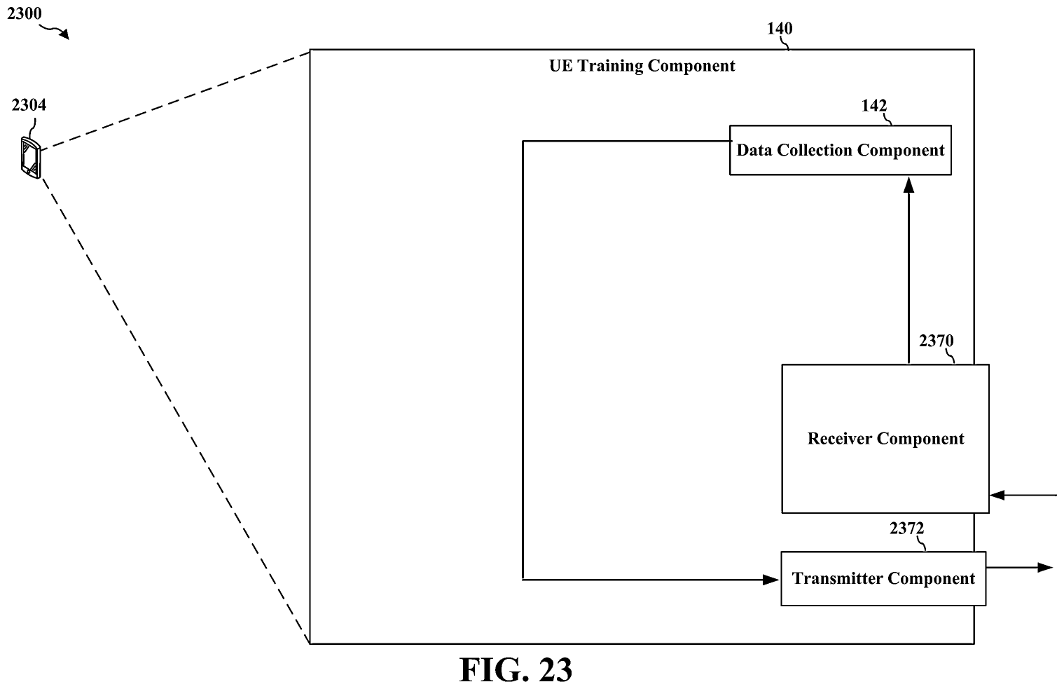

FIG. 23 is a conceptual data flow diagram 2300 illustrating the data flow between different means/components in an example UE 2304, which may be an example of the UE 104 and include the UE training component 140. As discussed with respect to FIG. 1, the UE training component 140 may include the data collection component 142.

The UE 104 also may include a receiver component 2370 and a transmitter component 2372. The receiver component 2370 may include, for example, a RF receiver for receiving the signals described herein. The transmitter component 2372 may include for example, an RF transmitter for transmitting the signals described herein. In some implementations, the receiver component 2370 and the transmitter component 2372 may be co-located in a transceiver such as the Tx/Rx 354 in FIG. 3.

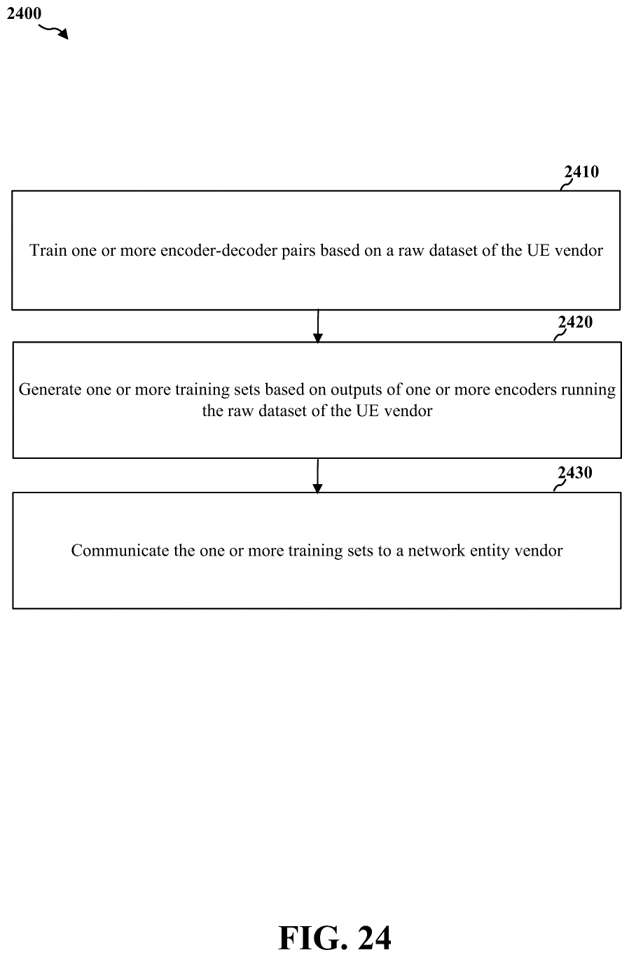

FIG. 24 is a flowchart of an example method 2400 for a UE vendor for cross-node machine learning training. The method 2400 may be performed by a UE vendor (such as the UE vendor 310/502, which may include the memory 360 and which may be the entire UE vendor 310/502 or a component of the UE vendor 310/502 such as Tx processor 368, the Rx processor 356, or the controller/processor 359).

At block 2410, the method 2400 includes training one or more encoder-decoder pairs based on a raw dataset of the UE vendor. In some implementations, for example, the UE vendor 310/502, the Rx processor 356, or the controller/processor 359 may be configured to train one or more encoder-decoder pairs based on a raw dataset of the UE vendor. Accordingly, the UE vendor 310/502, the Rx processor 356, or the controller/processor 359 may provide means for training one or more encoder-decoder pairs based on a raw dataset of the UE vendor.

At block 2420, the method 2400 includes generating one or more training sets based on outputs of one or more encoders running the raw dataset of the UE vendor. In some implementations, for example, the UE vendor 310/502, the Rx processor 356, or the controller/processor 359 may be configured to generate one or more training sets based on outputs of one or more encoders running the raw dataset of the UE vendor. Accordingly, the UE vendor 310/502, the Rx processor 356, or the controller/processor 359 may provide means for generating one or more training sets based on outputs of one or more encoders running the raw dataset of the UE vendor.

At block 2420, the method 2400 includes communicating the one or more training sets to a network entity vendor. In some implementations, for example, the UE vendor 310/502, the Rx processor 356, or the controller/processor 359 may be configured to communicate the one or more training sets to a network entity vendor. Accordingly, the UE vendor 310/502, the Rx processor 356, or the controller/processor 359 may provide means for communicating the one or more training sets to a network entity vendor.

In some implementations, each of the one or more training sets include an encoder identification (ID), encoder output, and desired decoder output.

In some implementations, each of the one or more training sets is associated with one or more metadata to enable switching between one or more models during inference.

In some implementations, the one or more metadata includes at least one of UE antenna configuration, signal-to-noise ratio (SNR), Reference Signal Receive Power (RSRP), delay speed, average delay, and time stamp.

In some implementations, the UE vendor 310/502, the Rx processor 356, or the controller/processor 359 may be configured to decompose the one or more metadata into UE meta-ID.

In some implementations, an encoder output of the one or more encoders corresponds to a compressed channel status information (CSI) feedback (CSF) message.

In some implementations, a decoder output of one or more decoders of the one or more encoder-decoder pairs includes a reconstructed CSF corresponding to one or more precoding vectors.

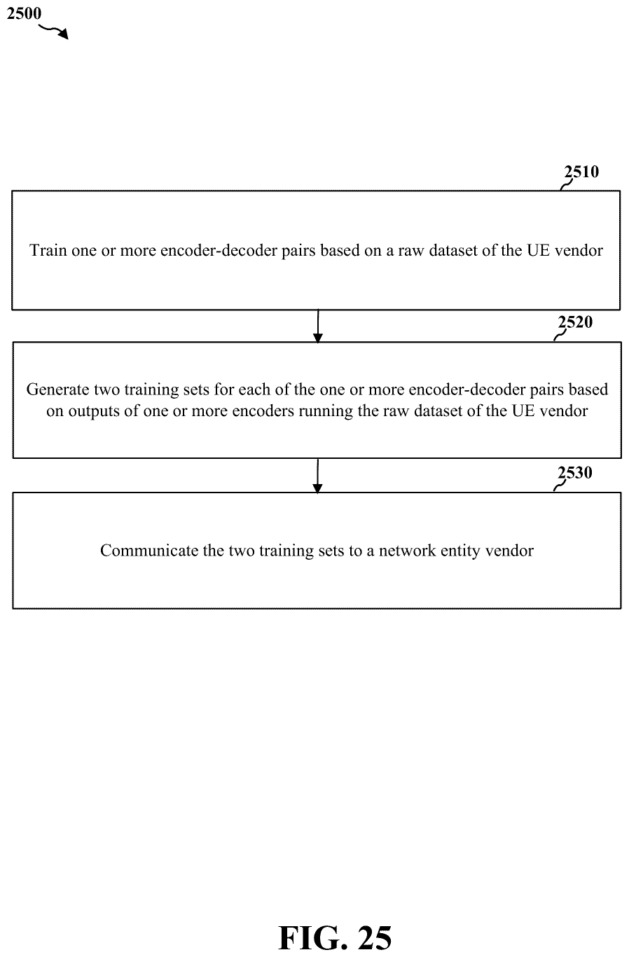

FIG. 25 a flowchart of an example method 2500 for a UE vendor for cross-node machine learning training. The method 2500 may be performed by a UE vendor (such as the UE vendor 310/502, which may include the memory 360 and which may be the entire UE vendor 310/502 or a component of the UE vendor 310/502 such as Tx processor 368, the Rx processor 356, or the controller/processor 359).

At block 2510, the method 2500 includes training one or more encoder-decoder pairs based on a raw dataset of the UE vendor. In some implementations, for example, the UE vendor 310/502, the Rx processor 356, or the controller/processor 359 may be configured to train one or more encoder-decoder pairs based on a raw dataset of the UE vendor. Accordingly, the UE vendor 310/502, the Rx processor 356, or the controller/processor 359 may provide means for training one or more encoder-decoder pairs based on a raw dataset of the UE vendor.

At block 2520, the method 2500 includes generating two training sets for each of the one or more encoder-decoder pairs based on outputs of one or more encoders running the raw dataset of the UE vendor. In some implementations, for example, the UE vendor 310/502, the Rx processor 356, or the controller/processor 359 may be configured to generate two training sets for each of the one or more encoder-decoder pairs based on outputs of one or more encoders running the raw dataset of the UE vendor. Accordingly, the UE vendor 310/502, the Rx processor 356, or the controller/processor 359 may provide means for generating two training sets for each of the one or more encoder-decoder pairs based on outputs of one or more encoders running the raw dataset of the UE vendor.

At block 2520, the method 2500 includes communicating the two training sets to a network entity vendor. In some implementations, for example, the UE vendor 310/502, the Rx processor 356, or the controller/processor 359 may be configured to communicate the two training sets to a network entity vendor. Accordingly, the UE vendor 310/502, the Rx processor 356, or the controller/processor 359 may provide means for communicating the two training sets to a network entity vendor.

In some implementations, generating the two training sets further comprises generating a first training set based on outputs of the encoder and decoder using the raw dataset of the UE vendor.

In some implementations, the first training set includes an encoder identification (ID), encoder output, and a reconstruction of a desired decoder output by the decoder.

In some implementations, generating the two training sets further comprises generating a second training set based on perturbing the encoder output in the first training set by a vector and computing a corresponding decoder output.

In some implementations, the second training set includes the encoder ID, a combination of the encoder output and the vector, and the corresponding decoder output.

In some implementations, the UE vendor 310/502, the Rx processor 356, or the controller/processor 359 may be configured to identify a substitute decoder that approximates the found decoder within one of the one or more encoder-decoder pairs; and communicate the substitute decoder to the network entity vendor.

In some implementations, the substitute decoder produces at least a similar output as the found decoder in response to a first training set and a second training set.

In some implementations, identifying the substitute decoder further comprises identifying a respective substitute decoder for each encoder ID corresponding to a respective encoder of the one or more encoder-decoder pairs.

In some implementations, an encoder output of the one or more encoders corresponds to a compressed channel status information (CSI) feedback (CSF) message.

In some implementations, a decoder output of one or more decoders of the one or more encoder-decoder pairs includes a reconstructed CSF corresponding to one or more precoding vectors.

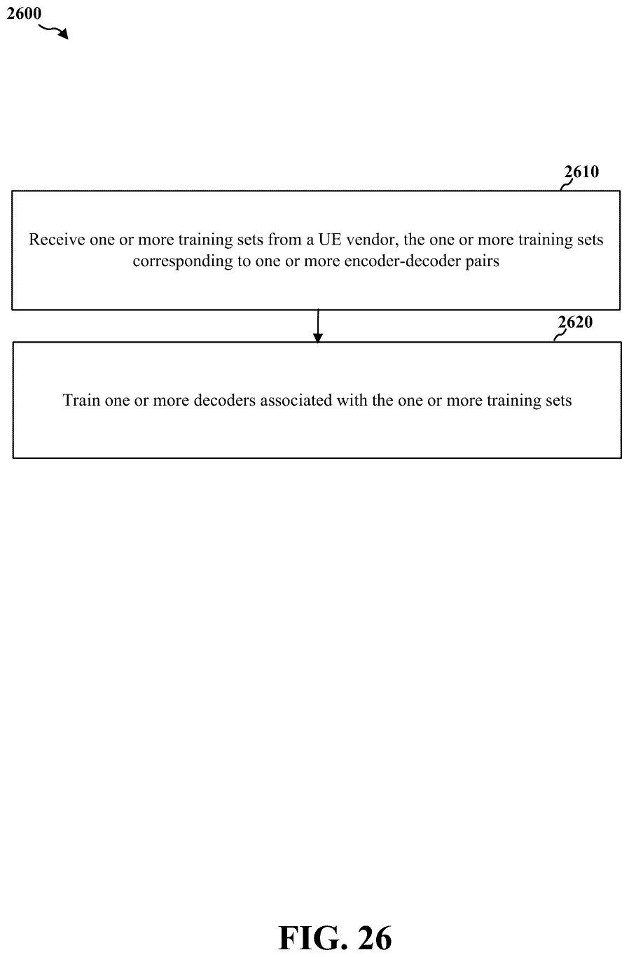

FIG. 26 is a flowchart of an example method 2600 for a network entity vendor for cross-node machine learning training. The method 2600 may be performed by a network entity vendor (such as the network entity/gNB vendor 316/504, which may include the memory 376 and which may be the network entity/gNB vendor 316/504 or a component of the network entity/gNB vendor 316/504 such as Tx processor 316, the Rx processor 370, or the controller/processor 375).

At block 2610, the method 2600 includes receiving one or more training sets from a UE vendor, the one or more training sets corresponding to one or more encoder-decoder pairs. In some implementations, for example, the network entity/gNB vendor 316/504, Tx processor 316, or the controller/processor 375 may be configured to receive one or more training sets from a UE vendor, the one or more training sets corresponding to one or more encoder-decoder pairs. Accordingly, the network entity/gNB vendor 316/504, Tx processor 316, or the controller/processor 375 may provide means for receiving one or more training sets from a UE vendor, the one or more training sets corresponding to one or more encoder-decoder pairs.

At block 2620, the method 2600 includes training one or more decoders associated with the one or more training sets. In some implementations, for example, the network entity/gNB vendor 316/504, Tx processor 316, or the controller/processor 375 may be configured to train one or more decoders associated with the one or more training sets. Accordingly, the network entity/gNB vendor 316/504, Tx processor 316, or the controller/processor 375 may provide means for training one or more decoders associated with the one or more training sets.

In some implementations, each of the one or more training sets include an encoder identification (ID), encoder output, and desired decoder output.

In some implementations, each of the one or more training sets is associated with one or more metadata to enable switching between one or more models during inference.

In some implementations, the one or more metadata includes at least one of UE antenna configuration, signal-to-noise ratio (SNR), Reference Signal Receive Power (RSRP), delay speed, average delay, and time stamp.

In some implementations, the network entity/gNB vendor 316/504, Tx processor 316, or the controller/processor 375 may be configured to determine whether the one or more decoders is associated with a network entity or shared across multiple network entities based on the one or more training sets.

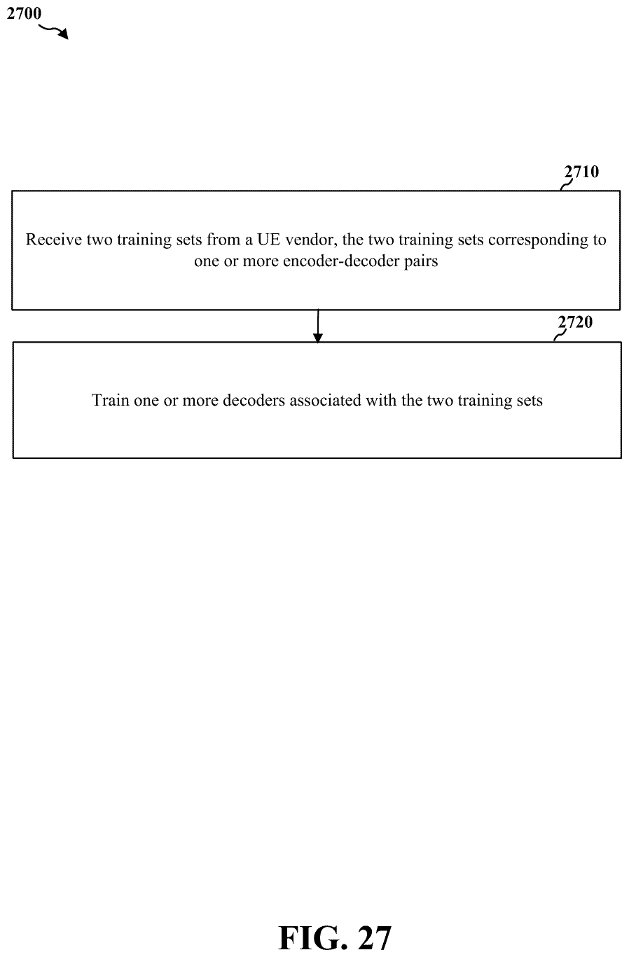

FIG. 27 is a flowchart of an example method 2700 for a network entity vendor for cross-node machine learning training. The method 2700 may be performed by a network entity vendor (such as the network entity/gNB vendor 316/504, which may include the memory 376 and which may be the network entity/gNB vendor 316/504 or a component of the network entity/gNB vendor 316/504 such as Tx processor 316, the Rx processor 370, or the controller/processor 375).

At block 2710, the method 2700 includes receiving two training sets from a UE vendor, the two training sets corresponding to one or more encoder-decoder pairs. In some implementations, for example, the network entity/gNB vendor 316/504, Tx processor 316, or the controller/processor 375 may be configured to receive two training sets from a UE vendor, the two training sets corresponding to one or more encoder-decoder pairs. Accordingly, the network entity/gNB vendor 316/504, Tx processor 316, or the controller/processor 375 may provide means for receiving two training sets from a UE vendor, the two training sets corresponding to one or more encoder-decoder pairs.

At block 2720, the method 2700 includes training one or more decoders associated with the two training sets. In some implementations, for example, the network entity/gNB vendor 316/504, Tx processor 316, or the controller/processor 375 may be configured to train one or more decoders associated with the two training sets. Accordingly, the network entity/gNB vendor 316/504, Tx processor 316, or the controller/processor 375 may provide means for training one or more decoders associated with the two training sets.

In some implementations, the first training set includes an encoder identification (ID), encoder output, and a reconstruction of a desired decoder output by the one or more decoders.

In some implementations, the second training set includes the encoder ID, a combination of the encoder output and the vector, and the corresponding decoder output.

In some implementations, the network entity/gNB vendor 316/504, Tx processor 316, or the controller/processor 375 may be configured to receive a substitute decoder that approximates the found decoder within one of the one or more encoder-decoder pairs.

In some implementations, the substitute decoder produces at least a similar output as the found decoder in response to a first training set and a second training set.

In some implementations, each of the two training sets is associated with one or more metadata to enable switching between one or more models during inference.

In some implementations, the one or more metadata includes at least one of UE antenna configuration, signal-to-noise ratio (SNR), Reference Signal Receive Power (RSRP), delay speed, average delay, and time stamp.

In some implementations, the network entity/gNB vendor 316/504, Tx processor 316, or the controller/processor 375 may be configured to determine whether the one or more decoders is associated with a network entity or shared across multiple network entities based on the two training sets.

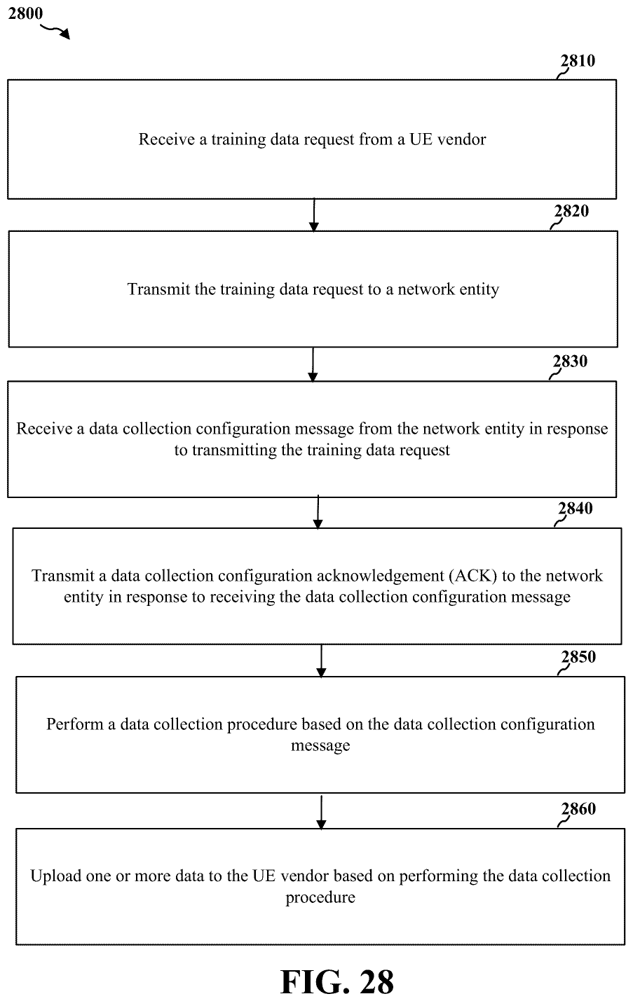

FIG. 28 is a flowchart of an example method 2800 for a UE to perform a CSF data collection procedure. The method 2800 may be performed by a UE (such as the UE 104, which may include the memory 360 and which may be the entire UE 104 or a component of the UE 104 such as Tx processor 368, the Rx processor 356, or the controller/processor 359).

At block 2810, the method 2800 includes receiving a training data request from a UE vendor. In some implementations, for example, the UE 104, the Rx processor 356, or the controller/processor 359 may be configured to receive a training data request from a UE vendor. Accordingly, the UE 104, the Rx processor 356, or the controller/processor 359 may provide means for receiving a training data request from a UE vendor.

At block 2820, the method 2800 includes transmitting the training data request to a network entity. In some implementations, for example, the UE 104, the Rx processor 356, or the controller/processor 359 may be configured to transmit the training data request to a network entity. Accordingly, the UE 104, the Rx processor 356, or the controller/processor 359 may provide means for transmitting the training data request to a network entity.

At block 2830, the method 2800 includes receiving a data collection configuration message from the network entity in response to transmitting the training data request. In some implementations, for example, the UE 104, the Rx processor 356, or the controller/processor 359 may be configured to receive a data collection configuration message from the network entity in response to transmitting the training data request. Accordingly, the UE 104, the Rx processor 356, or the controller/processor 359 may provide means for receiving a data collection configuration message from the network entity in response to transmitting the training data request.

At block 2840, the method 2800 includes transmitting a data collection configuration acknowledgement (ACK) to the network entity in response to receiving the data collection configuration message. In some implementations, for example, the UE 104, the Rx processor 356, or the controller/processor 359 may be configured to transmit a data collection configuration acknowledgement (ACK) to the network entity in response to receiving the data collection configuration message. Accordingly, the UE 104, the Rx processor 356, or the controller/processor 359 may provide means for transmitting a data collection configuration acknowledgement (ACK) to the network entity in response to receiving the data collection configuration message.

At block 2850, the method 2800 includes performing a data collection procedure based on the data collection configuration message. In some implementations, for example, the UE 104, the Rx processor 356, or the controller/processor 359 may be configured to perform a data collection procedure based on the data collection configuration message. Accordingly, the UE 104, the Rx processor 356, or the controller/processor 359 may provide means for performing a data collection procedure based on the data collection configuration message.

At block 2860, the method 2800 includes uploading one or more data to the UE vendor based on performing the data collection procedure. In some implementations, for example, the UE 104, the Rx processor 356, or the controller/processor 359 may be configured to upload one or more data to the UE vendor based on performing the data collection procedure. Accordingly, the UE 104, the Rx processor 356, or the controller/processor 359 may provide means for uploading one or more data to the UE vendor based on performing the data collection procedure.

In some implementations, the data collection configuration message includes a reference signal (RS) list for data collection, an area for data collection, a period for data collection, network side configuration, channel type, and a process identification (ID) on data collection.

In some implementations, the process ID corresponds to a model ID registered with a machine learning function (MLF).

In some implementations, the UE 104, the Rx processor 356, or the controller/processor 359 may be configured to generate a meta-ID for data uploading corresponding to one or more metadata based on the process ID.

In some implementations, receiving the data collection configuration message further comprises receiving the data collection configuration message as at least one of information elements in a radio resource control (RRC) reconfiguration message or a new signaling procedure.

In some implementations, the one or more data corresponds to a UE report including a downlink raw channel matrix and a metadata identification (meta-ID).

In some implementations, the downlink raw channel matrix corresponds to a channel estimation based on a resource block (RB) index, port index, and receiver index.

In some implementations, the meta-ID includes a data package ID, a cell/carrier ID, a channel status information (CSI) reference signal (RS) resource ID, a list of one or more records, and a Global Navigation Satellite System (GNSS).

In some implementations, the list of one or more records includes at least one of a time stamp, one of a signal-to-noise ratio (SNR), signal-to-interference and noise ratio (SINR), or Reference Signal Receive Power (RSRP), subcarrier spacing, and a Doppler/delay-spread measurement.

In some implementations, a format of the UE report including the downlink raw channel matrix corresponds to a frequency domain resolution and Eigen directions of the downlink raw channel matrix.

In some implementations, the UE 104, the Rx processor 356, or the controller/processor 359 configured to perform the data collection procedure further comprises: receiving a reference signal (RS) from the network entity in response to transmitting the data collection configuration ACK; and performing one or more measurements based on the RS.

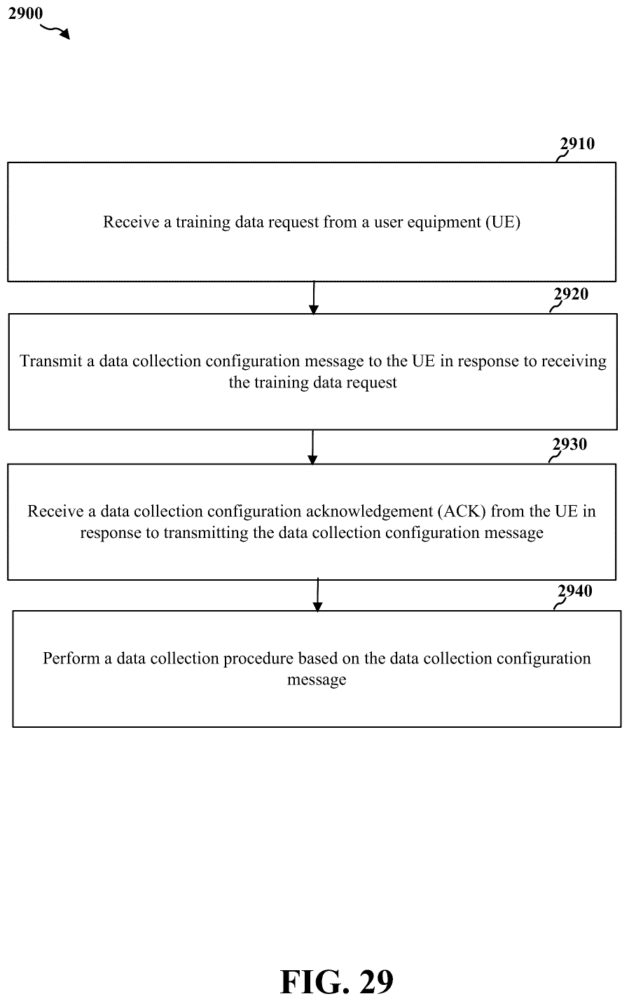

FIG. 29 is a flowchart of an example method 2900 for a network entity to perform a CSF data collection procedure. The method 2900 may be performed by a network entity (such as the network entity 102, which may include the memory 376 and which may be the network entity 102 or a component of the network entity 102 such as Tx processor 316, the Rx processor 370, or the controller/processor 375).

At block 2810, the method 2800 includes receiving a training data request from a user equipment (UE). In some implementations, for example, the network entity 102, Tx processor 316, or the controller/processor 375 may be configured to receive a training data request from a user equipment (UE). Accordingly, the network entity 102, Tx processor 316, or the controller/processor 375 may provide means for receiving a training data request from a user equipment (UE).

At block 2820, the method 2800 includes transmitting a data collection configuration message to the UE in response to receiving the training data request. In some implementations, for example, the network entity 102, Tx processor 316, or the controller/processor 375 may be configured to transmit a data collection configuration message to the UE in response to receiving the training data request. Accordingly, the network entity 102, Tx processor 316, or the controller/processor 375 may provide means for transmitting a data collection configuration message to the UE in response to receiving the training data request.

At block 2830, the method 2800 includes receiving a data collection configuration acknowledgement (ACK) from the UE in response to transmitting the data collection configuration message. In some implementations, for example, the network entity 102, Tx processor 316, or the controller/processor 375 may be configured to receive a data collection configuration acknowledgement (ACK) from the UE in response to transmitting the data collection configuration message. Accordingly, the network entity 102, Tx processor 316, or the controller/processor 375 may provide means for receiving a data collection configuration acknowledgement (ACK) from the UE in response to transmitting the data collection configuration message.

At block 2840, the method 2800 includes performing a data collection procedure based on the data collection configuration message. In some implementations, for example, the network entity 102, Tx processor 316, or the controller/processor 375 may be configured to perform a data collection procedure based on the data collection configuration message. Accordingly, the network entity 102, Tx processor 316, or the controller/processor 375 may provide means for performing a data collection procedure based on the data collection configuration message.

In some implementations, performing the data collection procedure further comprises transmitting a reference signal (RS) to the UE in response to receiving the data collection configuration ACK.

In some implementations, the data collection configuration message includes a reference signal (RS) list for data collection, an area for data collection, a period for data collection, network side configuration, channel type, and a process identification (ID) on data collection.

In some implementations, the process ID corresponds to a model ID registered with a machine learning function (MLF).

In some implementations, transmitting the data collection configuration message further comprises transmitting the data collection configuration message as at least one of information elements in a radio resource control (RRC) reconfiguration message or a new signaling procedure.

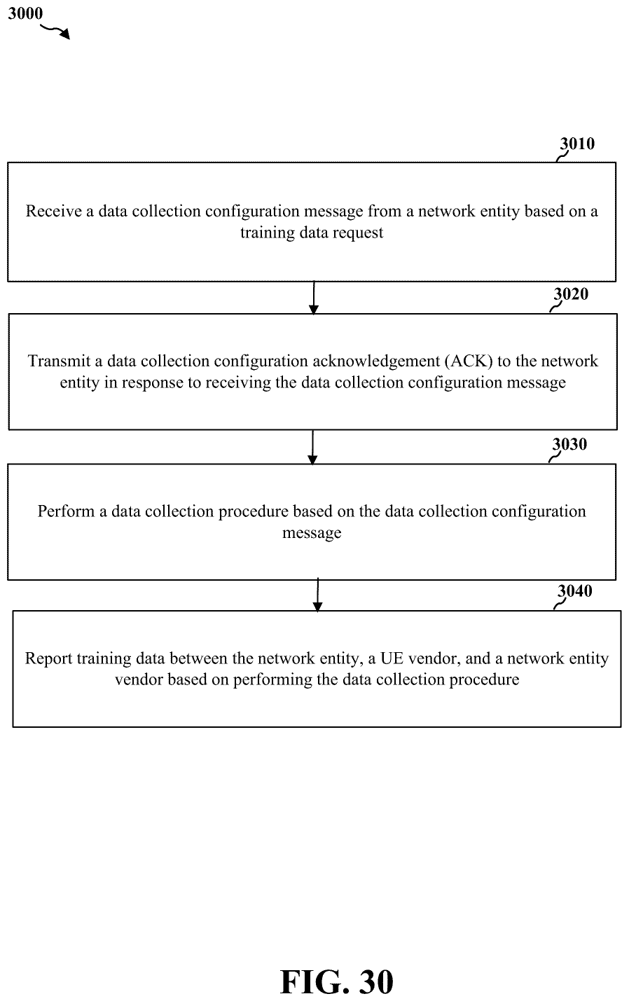

FIG. 30 is a flowchart of an example method 3000 for a UE to perform a CSF data collection procedure. The method 3000 may be performed by a UE (such as the UE 104, which may include the memory 360 and which may be the entire UE 104 or a component of the UE 104 such as Tx processor 368, the Rx processor 356, or the controller/processor 359).

At block 3010, the method 3000 includes receiving a data collection configuration message from a network entity based on a training data request. In some implementations, for example, the UE 104, the Rx processor 356, or the controller/processor 359 may be configured to receive a data collection configuration message from a network entity based on a training data request. Accordingly, the UE 104, the Rx processor 356, or the controller/processor 359 may provide means for receiving a data collection configuration message from a network entity based on a training data request.

At block 3020, the method 3000 includes transmitting a data collection configuration acknowledgement (ACK) to the network entity in response to receiving the data collection configuration message. In some implementations, for example, the UE 104, the Rx processor 356, or the controller/processor 359 may be configured to transmit a data collection configuration acknowledgement (ACK) to the network entity in response to receiving the data collection configuration message. Accordingly, the UE 104, the Rx processor 356, or the controller/processor 359 may provide means for transmitting a data collection configuration acknowledgement (ACK) to the network entity in response to receiving the data collection configuration message.

At block 3030, the method 3000 includes performing a data collection procedure based on the data collection configuration message. In some implementations, for example, the UE 104, the Rx processor 356, or the controller/processor 359 may be configured to perform a data collection procedure based on the data collection configuration message. Accordingly, the UE 104, the Rx processor 356, or the controller/processor 359 may provide means for performing a data collection procedure based on the data collection configuration message.

At block 3040, the method 3000 includes reporting training data between the network entity, a UE vendor, and a network entity vendor based on performing the data collection procedure. In some implementations, for example, the UE 104, the Rx processor 356, or the controller/processor 359 may be configured to report training data between the network entity, a UE vendor, and a network entity vendor based on performing the data collection procedure. Accordingly, the UE 104, the Rx processor 356, or the controller/processor 359 may provide means for reporting training data between the network entity, a UE vendor, and a network entity vendor based on performing the data collection procedure.

In some implementations, reporting training data further comprises reporting the training data using at least one of a minimizing driving test (MDT) enhancement, vendor-UE-vendor, and vendor-to-vendor.

In some implementations, reporting the training data using the MDT enhancement includes transmitting the training data to the network entity.

In some implementations, reporting the training data using the vendor-UE-vendor includes: reporting the training data to the UE vendor; and transmitting data or a data address report to the network entity.

In some implementations, reporting the training data using the vendor-to-vendor includes reporting the training data to the UE vendor.

In some implementations, the data collection configuration message includes a reference signal (RS) list for data collection, an area for data collection, a period for data collection, network side configuration, channel type, and a process identification (ID) on data collection.

In some implementations, the process ID corresponds to a model ID registered with a machine learning function (MLF).

In some implementations, receiving the data collection configuration message further comprises receiving the data collection configuration message as at least one of information elements in a radio resource control (RRC) reconfiguration message or a new signaling procedure.

In some implementations, performing the data collection procedure further comprises: receiving a reference signal (RS) from the network entity in response to transmitting the data collection configuration ACK; and performing one or more measurements based on the RS.

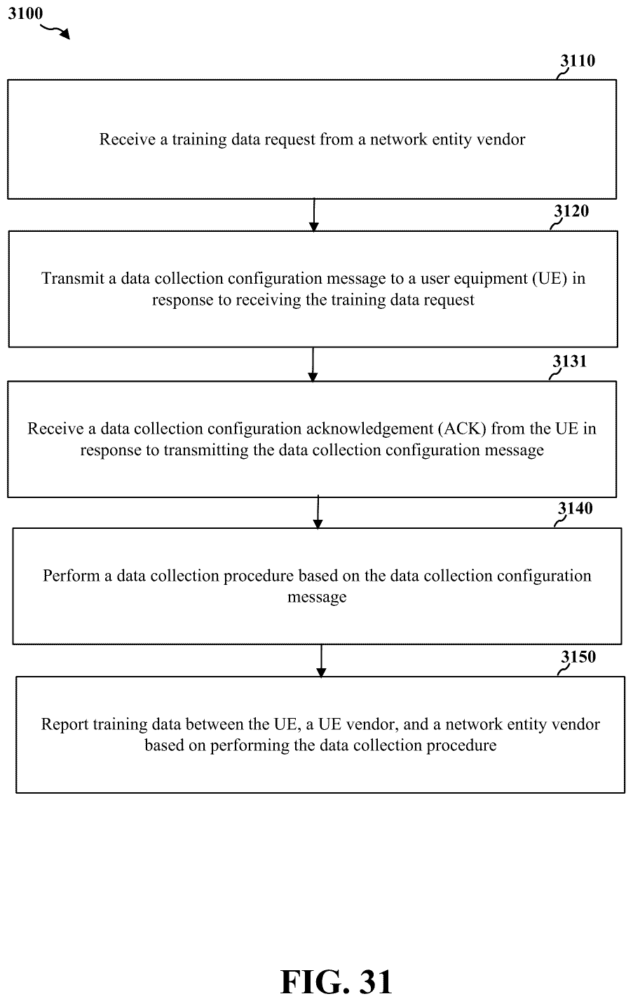

FIG. 31 is a flowchart of an example method 3100 for a network entity to perform a CSF data collection procedure. The method 3100 may be performed by a network entity (such as the network entity 102, which may include the memory 376 and which may be the network entity 102 or a component of the network entity 102 such as Tx processor 316, the Rx processor 370, or the controller/processor 375).

At block 3110, the method 3100 includes receiving a training data request from a network entity vendor. In some implementations, for example, the network entity 102, Tx processor 316, or the controller/processor 375 may be configured to receive a training data request from a network entity vendor. Accordingly, the network entity 102, Tx processor 316, or the controller/processor 375 may provide means for receiving a training data request from a network entity vendor.

At block 3120, the method 3100 includes transmitting a data collection configuration message to a user equipment (UE) in response to receiving the training data request. In some implementations, for example, the network entity 102, Tx processor 316, or the controller/processor 375 may be configured to transmit a data collection configuration message to a user equipment (UE) in response to receiving the training data request. Accordingly, the network entity 102, Tx processor 316, or the controller/processor 375 may provide means for transmitting a data collection configuration message to a user equipment (UE) in response to receiving the training data request.

At block 3130, the method 3100 includes receiving a data collection configuration acknowledgement (ACK) from the UE in response to transmitting the data collection configuration message. In some implementations, for example, the network entity 102, Tx processor 316, or the controller/processor 375 may be configured to receive a data collection configuration acknowledgement (ACK) from the UE in response to transmitting the data collection configuration message. Accordingly, the network entity 102, Tx processor 316, or the controller/processor 375 may provide means for receiving a data collection configuration acknowledgement (ACK) from the UE in response to transmitting the data collection configuration message.

At block 3140, the method 3100 includes performing a data collection procedure based on the data collection configuration message. In some implementations, for example, the network entity 102, Tx processor 316, or the controller/processor 375 may be configured to perform a data collection procedure based on the data collection configuration message. Accordingly, the network entity 102, Tx processor 316, or the controller/processor 375 may provide means for performing a data collection procedure based on the data collection configuration message.

At block 3150, the method 3100 includes reporting training data between the UE, a UE vendor, and a network entity vendor based on performing the data collection procedure. In some implementations, for example, the network entity 102, Tx processor 316, or the controller/processor 375 may be configured to report training data between the UE, a UE vendor, and a network entity vendor based on performing the data collection procedure. Accordingly, the network entity 102, Tx processor 316, or the controller/processor 375 may provide means for reporting training data between the UE, a UE vendor, and a network entity vendor based on performing the data collection procedure.

In some implementations, reporting training data further comprises reporting the training data using at least one of a minimizing driving test (MDT) enhancement, vendor-UE-vendor, and vendor-to-vendor.

In some implementations, reporting the training data using the MDT enhancement includes: receiving the training data from the UE; and forwarding the training data to the network entity vendor.

In some implementations, reporting the training data using the vendor-UE-vendor includes: receiving data or a data address report from the UE; and forwarding the data or the data address report to the network entity vendor.

In some implementations, performing the data collection procedure further comprises transmitting a reference signal (RS) to the UE in response to receiving the data collection configuration ACK.

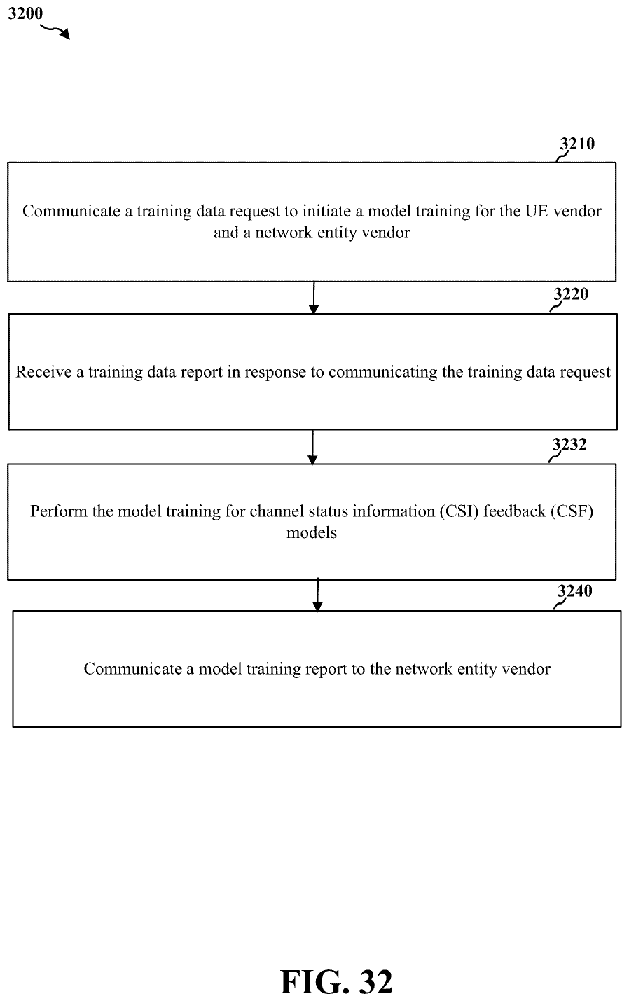

FIG. 32 is a flowchart of an example method 3200 for a UE vendor to perform data collection and offline model training for CSF compression. The method 3200 may be performed by a UE vendor (such as the UE vendor 310/502, which may include the memory 360 and which may be the entire UE vendor 310/502 or a component of the UE vendor 310/502 such as Tx processor 368, the Rx processor 356, or the controller/processor 359).

At block 3210, the method 3200 includes communicating a training data request to initiate a model training for the UE vendor and a network entity vendor. In some implementations, for example, the UE vendor 310/502, the Rx processor 356, or the controller/processor 359 may be configured to communicate a training data request to initiate a model training for the UE vendor and a network entity vendor. Accordingly, the UE vendor 310/502, the Rx processor 356, or the controller/processor 359 may provide means for communicating a training data request to initiate a model training for the UE vendor and a network entity vendor.

At block 3220, the method 3200 includes receiving a training data report in response to communicating the training data request. In some implementations, for example, the UE vendor 310/502, the Rx processor 356, or the controller/processor 359 may be configured to receive a training data report in response to communicating the training data request. Accordingly, the UE vendor 310/502, the Rx processor 356, or the controller/processor 359 may provide means for receiving a training data report in response to communicating the training data request.

At block 3230, the method 3200 includes performing the model training for channel status information (CSI) feedback (CSF) models. In some implementations, for example, the UE vendor 310/502, the Rx processor 356, or the controller/processor 359 may be configured to perform the model training for channel status information (CSI) feedback (CSF) models. Accordingly, the UE vendor 310/502, the Rx processor 356, or the controller/processor 359 may provide means for performing the model training for channel status information (CSI) feedback (CSF) models.

At block 3240, the method 3200 includes communicating a model training report to the network entity vendor. In some implementations, for example, the UE vendor 310/502, the Rx processor 356, or the controller/processor 359 may be configured to communicate a model training report to the network entity vendor. Accordingly, the UE vendor 310/502, the Rx processor 356, or the controller/processor 359 may provide means for communicating a model training report to the network entity vendor.

In some implementations, communicating the training data request further comprises communicating the training data request to the network entity vendor to initiate model training.

In some implementations, the UE vendor 310/502, the Rx processor 356, or the controller/processor 359 may be configured to receive a training data request acknowledgement (ACK) from the network entity vendor in response to communicating the training data request.

In some implementations, communicating the training data request further comprises communicating the training data request to a UE to collect data for the model training.

In some implementations, the UE vendor 310/502, the Rx processor 356, or the controller/processor 359 may be configured to register one or more CSF models with a network associated with the UE vendor and the network entity vendor.

In some implementations, registering the one or more CSF models includes registering one or more model identifications (IDs) or model structure (MS) IDs, list of parameter set (PS) IDs, and applicable scenarios for each PS including an area, configuration and UE type.

In some implementations, the training data report includes at least one of a timestamp, location information, and metadata.

In some implementations, the timestamp corresponds to at least one of an absolute time, relative time, or a combination of a system frame number (SFN), timeslot, and an optional symbol.

In some implementations, the location information includes at least one of a Global Navigation Satellite System (GNSS) and a radio fingerprint corresponding to a Reference Signal Receive Power (RSRP)/Reference Signal Received Quality (RSRQ) measurement of a serving cell and neighbor cells.

In some implementations, the metadata includes at least one of a reference signal (RS) type identification (ID) and NM ID.

In some implementations, communicating the model training further comprises either directly uploading the model training or distilling data for a network entity to derive the model training.

In some implementations, the distilled data for the network entity corresponds to a UE report including a downlink raw channel matrix and a metadata identification (meta-ID).

In some implementations, the downlink raw channel matrix corresponds to a channel estimation based on a resource block (RB) index, port index, and receiver index.

In some implementations, the meta-ID includes a cell ID, a channel status information (CSI) reference signal (RS) resource ID, and a list of one or more records.

In some implementations, the list of one or more records includes at least one of a time stamp, one of a signal-to-noise ratio (SNR), signal-to-interference and noise ratio (SINR), or Reference Signal Receive Power (RSRP), subcarrier spacing, and a Doppler/delay-spread measurement.

In some implementations, a format of the UE report including the downlink raw channel matrix corresponds to a frequency domain resolution and Eigen directions of the downlink raw channel matrix.

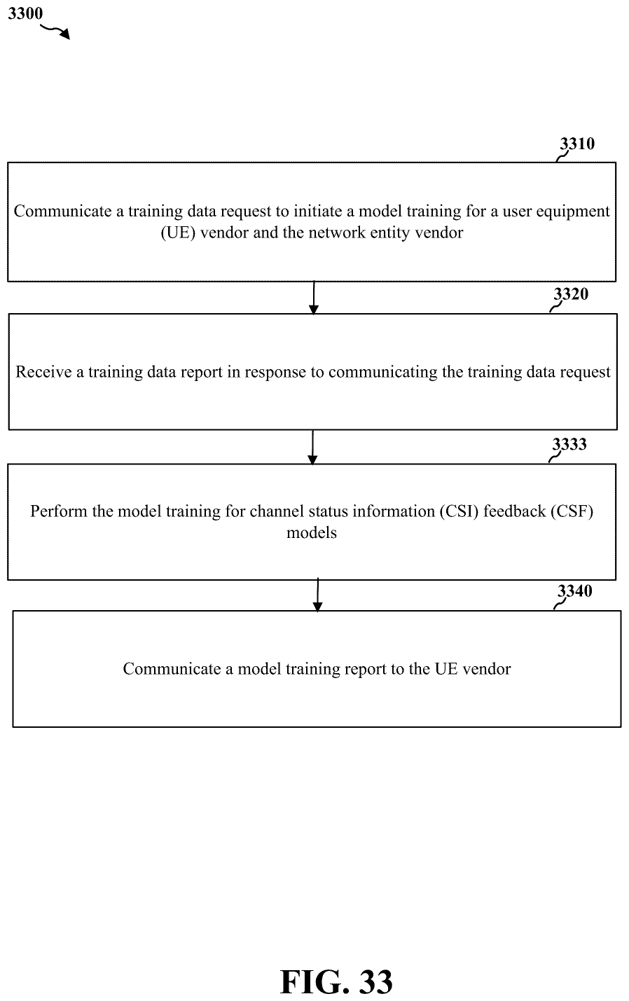

FIG. 33 is a flowchart of an example method 3300 for a network entity vendor to perform data collection and offline model training for CSF compression. The method 3300 may be performed by a network entity vendor (such as the network entity/gNB vendor 316/504, which may include the memory 376 and which may be the network entity/gNB vendor 316/504 or a component of the network entity/gNB vendor 316/504 such as Tx processor 316, the Rx processor 370, or the controller/processor 375).

At block 3310, the method 3300 includes communicating a training data request to initiate a model training for a user equipment (UE) vendor and the network entity vendor. In some implementations, for example, the network entity/gNB vendor 316/504, Tx processor 316, or the controller/processor 375 may be configured to communicate a training data request to initiate a model training for a user equipment (UE) vendor and the network entity vendor. Accordingly, the network entity/gNB vendor 316/504, Tx processor 316, or the controller/processor 375 may provide means for communicating a training data request to initiate a model training for a user equipment (UE) vendor and the network entity vendor.

At block 3320, the method 3300 includes receiving a training data report in response to communicating the training data request. In some implementations, for example, the network entity/gNB vendor 316/504, Tx processor 316, or the controller/processor 375 may be configured to receive a training data report in response to communicating the training data request. Accordingly, the network entity/gNB vendor 316/504, Tx processor 316, or the controller/processor 375 may provide means for receiving a training data report in response to communicating the training data request.

At block 3330, the method 3300 includes performing the model training for channel status information (CSI) feedback (CSF) models. In some implementations, for example, the network entity/gNB vendor 316/504, Tx processor 316, or the controller/processor 375 may be configured to perform the model training for channel status information (CSI) feedback (CSF) models. Accordingly, the network entity/gNB vendor 316/504, Tx processor 316, or the controller/processor 375 may provide means for performing the model training for channel status information (CSI) feedback (CSF) models.

At block 3340, the method 3300 includes communicating a model training report to the UE vendor. In some implementations, for example, the network entity/gNB vendor 316/504, Tx processor 316, or the controller/processor 375 may be configured to communicate a model training report to the UE vendor. Accordingly, the network entity/gNB vendor 316/504, Tx processor 316, or the controller/processor 375 may provide means for communicating a model training report to the UE vendor.

In some implementations, communicating the training data request further comprises communicating the training data request to a model manager to forward to a network entity for performing a UE selection procedure.

In some implementations, communicating the training data request further comprises communicating the training data request to model manager to for performing a UE selection procedure.

In some implementations, the network entity/gNB vendor 316/504, Tx processor 316, or the controller/processor 375 may be configured to register one or more CSF models with a network associated with the UE vendor and the network entity vendor.

In some implementations, registering the one or more CSF models includes registering one or more model identifications (IDs) or model structure (MS) IDs, list of parameter set (PS) IDs, and applicable scenarios for each PS including an area, configuration and UE type.

In some implementations, communicating the model training further comprises either directly uploading the model training or distilling data for a network entity to derive the model training.

In some implementations, the distilled data for the network entity corresponds to a UE report including a downlink raw channel matrix and a metadata identification (meta-ID).

In some implementations, the downlink raw channel matrix corresponds to a channel estimation based on a resource block (RB) index, port index, and receiver index.

In some implementations, the meta-ID includes a cell ID, a channel status information (CSI) reference signal (RS) resource ID, and a list of one or more records.

In some implementations, receiving the training data report further comprises receiving the training data report using at least one of a minimizing driving test (MDT) enhancement and vendor-to-vendor.

In some implementations, receiving the training data report using the MDT enhancement includes receiving the training data report from a model manager.

In some implementations, receiving the training data report using the vendor-to-vendor includes receiving the training data report from the UE vendor with a proprietary protocol.

An Appendix is included that is part of the present application and provides additional details related to the various aspects of the present disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication for a user equipment (UE), comprising:
receiving a training data request from a UE vendor;
transmitting the training data request to a network entity;
receiving a data collection configuration message from the network entity in response to transmitting the training data request;
transmitting a data collection configuration acknowledgement (ACK) to the network entity in response to receiving the data collection configuration message;
performing a data collection procedure based on the data collection configuration message; and
uploading one or more data to the UE vendor based on performing the data collection procedure.

2. The method of claim 1, wherein the data collection configuration message includes a reference signal (RS) list for data collection, an area for data collection, a period for data collection, network side configuration, channel type, and a process identification (ID) on data collection.

3. The method of claim 2, wherein the process ID corresponds to a model ID registered with a machine learning function (MLLF).

4. The method of claim 2, further comprising generating a meta-ID for data uploading corresponding to one or more metadata based on the process ID.

5. The method of claim 1, wherein receiving the data collection configuration message further comprises receiving the data collection configuration message as at least one of information elements in a radio resource control (RRC) reconfiguration message or a new signaling procedure.

6. The method of claim 1, where the one or more data corresponds to a UE report including a downlink raw channel matrix and a metadata identification (meta-ID).

7. The method of claim 6, wherein the downlink raw channel matrix corresponds to a channel estimation based on a resource block (RB) index, port index, and receiver index.

8. The method of claim 6, wherein the meta-ID includes a data package ID, a cell/carrier ID, a channel status information (CSI) reference signal (RS) resource ID, a list of one or more records, and a Global Navigation Satellite System (GNSS).

9. The method of claim 8, wherein the list of one or more records includes at least one of a time stamp, one of a signal-to-noise ratio (SNR), signal-to-interference and noise ratio (SINR), or Reference Signal Receive Power (RSRP), subcarrier spacing, and a Doppler/delay-spread measurement.

10. The method of claim 6, wherein a format of the UE report including the downlink raw channel matrix corresponds to a frequency domain resolution and Eigen directions of the downlink raw channel matrix.

11. The method of claim 1, wherein performing the data collection procedure further comprises:
receiving a reference signal (RS) from the network entity in response to transmitting the data collection configuration ACK; and
performing one or more measurements based on the RS.

12. A method of wireless communication for a network entity, comprising:
receiving a training data request from a user equipment (UE);
transmitting a data collection configuration message to the UE in response to receiving the training data request;
receiving a data collection configuration acknowledgement (ACK) from the UE in response to transmitting the data collection configuration message; and
performing a data collection procedure based on the data collection configuration message.

13. The method of claim 12, wherein performing the data collection procedure further comprises transmitting a reference signal (RS) to the UE in response to receiving the data collection configuration ACK.

14. The method of claim 12, wherein the data collection configuration message includes a reference signal (RS) list for data collection, an area for data collection, a period for data collection, network side configuration, channel type, and a process identification (ID) on data collection.

15. The method of claim 14, wherein the process ID corresponds to a model ID registered with a machine learning function (MLLF).

16. The method of claim 1, wherein transmitting the data collection configuration message further comprises transmitting the data collection configuration message as at least one of information elements in a radio resource control (RRC) reconfiguration message or a new signaling procedure.

17. A method of wireless communication for a user equipment (UE), comprising:
receiving a data collection configuration message from a network entity based on a training data request;
transmitting a data collection configuration acknowledgement (ACK) to the network entity in response to receiving the data collection configuration message;
performing a data collection procedure based on the data collection configuration message; and
reporting training data between the network entity, a UE vendor, and a network entity vendor based on performing the data collection procedure.

18. The method of claim 17, wherein reporting training data further comprises reporting the training data using at least one of a minimizing driving test (MDT) enhancement, vendor-UE-vendor, and vendor-to-vendor.

19. The method of claim 18, wherein reporting the training data using the MDT enhancement includes transmitting the training data to the network entity.

20. The method of claim 18, wherein reporting the training data using the vendor-UE-vendor includes:
reporting the training data to the UE vendor; and
transmitting data or a data address report to the network entity.

21. The method of claim 18, wherein reporting the training data using the vendor-to-vendor includes reporting the training data to the UE vendor.

22. The method of claim 17, wherein the data collection configuration message includes a reference signal (RS) list for data collection, an area for data collection, a period for data collection, network side configuration, channel type, and a process identification (ID) on data collection.

23. The method of claim 22, wherein the process ID corresponds to a model ID registered with a machine learning function (MLF).

24. The method of claim 17, wherein receiving the data collection configuration message further comprises receiving the data collection configuration message as at least one of information elements in a radio resource control (RRC) reconfiguration message or a new signaling procedure.

25. The method of claim 17, wherein performing the data collection procedure further comprises:
receiving a reference signal (RS) from the network entity in response to transmitting the data collection configuration ACK; and
performing one or more measurements based on the RS.

26. A method of wireless communication for a network entity, comprising:
receiving a training data request from a network entity vendor;
transmitting a data collection configuration message to a user equipment (UE) in response to receiving the training data request;
receiving a data collection configuration acknowledgement (ACK) from the UE in response to transmitting the data collection configuration message;
performing a data collection procedure based on the data collection configuration message; and
reporting training data between the UE, a UE vendor, and a network entity vendor based on performing the data collection procedure.

27. The method of claim 26, wherein reporting training data further comprises reporting the training data using at least one of a minimizing driving test (MDT) enhancement, vendor-UE-vendor, and vendor-to-vendor.

28. The method of claim 27, wherein reporting the training data using the MDT enhancement includes:
receiving the training data from the UE; and
forwarding the training data to the network entity vendor.

29. The method of claim 18, wherein reporting the training data using the vendor-UE-vendor includes:
receiving data or a data address report from the UE; and
forwarding the data or the data address report to the network entity vendor.

30. The method of claim 26, wherein performing the data collection procedure further comprises transmitting a reference signal (RS) to the UE in response to receiving the data collection configuration ACK.
